(19) United States
(12) Patent Application Publication
(10) Pub. No.: US 2026/0222965 A1
(43) Pub. Date: Jul. 30, 2026

(54) METHOD, APPARATUS AND SYSTEM FOR TRAFFIC ROUTING

(71) Applicant: Huawei Technologies Co., Ltd., Shenzhen (CN)

(72) Inventors: Xu Li, Nepean (CA); Chenchen Yang, Ottawa (CA); Weisen Shi, Ottawa (CA); Bidi Ying, Ottawa (CA)

(21) Appl. No.: 19/630,119

(22) Filed: Mar. 26, 2026

Related U.S. Application Data
(63) Continuation of application No. PCT/CN2024/074123, filed on Jan. 25, 2024.
(60) Provisional application No. 63/586,733, filed on Sep. 29, 2023.

(51) Int. Cl. H04W 40/20

(52) U.S. Cl. CPC H04W 40/20

(57) ABSTRACT

This application provides a communication method and apparatus for traffic routing. In accordance with the method, an application function (AF) sends first information about traffic routing requirements to a policy control function (PCF). The first information about traffic routing requirements is used to obtain a target application location, from one or more application locations, for a device. Traffic originated from the device is routed to the target application location. The first information about traffic routing requirements is further used to indicate the privacy requirements during a period when the traffic is routed between the device and the target application location. The data plane path is selected and configured according to the first information about traffic routing requirements.

### CROSS-REFERENCE TO RELATED APPLICATIONS

This application is a continuation of International Patent Application No. PCT/CN2024/074123, filed on January 25, 2024, which claims the benefits of U.S. Provisional Application No. 63/586,733, filed on September 29, 2023, the disclosures of which are hereby incorporated by reference in their entireties.

### TECHNICAL FIELD

The present disclosure generally relates to the field of wireless communication, and in particular, to a method, apparatus and system for traffic routing, and a computer readable storage medium.

### BACKGROUND

When a device accesses an application through a communication system, e.g. the 5G system or future 6G system, the communication system connects the device to an application location, that is, a network location where the application is located, through a data plane path. The application location corresponds to an application server hosting or running the application. After the device has accessed the application, the device communicates with the application server through the data plane path. There may be more than one application location related to the application. If a plurality of devices access the application, the communication system needs to select appropriate application location(s) for the plurality of devices.

This background information is provided to reveal information believed by the applicant to be of possible relevance to the present disclosure. No admission is necessarily intended, nor should be construed, that any of the preceding information constitutes prior art against the present disclosure.

### SUMMARY

The present disclosure provides a method for traffic routing to help improve data transmission efficiency and protect privacy during data transmission.

According to a first aspect, a method performed by an application function (AF) network entity is provided. The method includes: sending first information about traffic routing requirements to a policy control function (PCF) network entity, wherein the first information about traffic routing requirements includes: a first indication indicating a value, wherein the first indication indicates that a number of devices whose traffic is to be routed to a target application location is greater than or equal to the value, and the target application location is to receive traffic from at least one first device; and/or a second indication indicating that a source of the traffic originated from the at least one first device is to be indistinguishable to the target application location.

Therefore, the AF may request to influence traffic routing by sending the first information about traffic routing requirements to the PCF. In this way, appropriate application locations may be selected for different devices according to the first information about traffic routing requirements. According to the first information about traffic routing requirements, traffic originated from different devices may be routed to different application locations instead of being routed to a common application location, thereby improving the traffic routing performance. In addition, the source of the traffic originated from the at least one first device will become indistinguishable to the target application location. In this way, the target application location will not know which device(s) the traffic is originated from, thereby achieving privacy protection.

Please note that what the first indication indicates is a requirement on the number of devices whose traffic is to be routed to a target application location. In addition, what the second indication indicates is a requirement on the indistinguishability of the traffic that is to be routed to a target application location.

In a possible implementation, the method further includes: obtaining the first information about traffic routing requirements.

In another possible implementation, the second indication indicates that the source of the traffic originated from the at least one first device is to be identified by a same address. In this way, the source of the traffic originated from the at least one first device will become indistinguishable to the target application location, thereby achieving privacy protection of the devices.

In another possible implementation, the first information about traffic routing requirements further includes at least one of: device information about one or more devices, wherein the at least one first device belongs to the one or more devices; application location information about one or more application locations, wherein the one or more application locations include the target application location; or traffic information about traffic originated from the one or more devices.

In this case, the one or more devices whose traffic (i.e., application traffic) is to be routed may be identified by the device information. The first target application location may be selected from the application locations that are identified by the application location information. Traffic originated from the one or more devices that need to be routed is identified by the traffic information.

In another possible implementation, the device information about the at least one first device includes at least one of: a first address of each of the at least one first device, a first identifier (ID) of each of the at least one first device, a common address for the at least one first device, or a common ID for the at least one first device.

In another possible implementation, the first information about traffic routing requirements further includes subscription information indicating subscription of one or more notifications, and each notification indicates whether the number of the devices whose traffic is routed to the target application location is greater than or equal to the value, and/or whether the source of the traffic originated from the at least one first device is indistinguishable to the target application location.

In this way, the AF may subscribe to the notifications of the events about the traffic routing requirements, and thus may know if the traffic routing requirements are satisfied.

In another possible implementation, the method further includes: receiving a first notification from a traffic coordination function (TCF) network entity, wherein the first notification indicates whether the number of the devices whose traffic is routed to the target application location is greater than or equal to the value; and/or receiving a second notification from the TCF network entity, wherein the second notification indicates whether the source of the traffic originated from the at least one first device is indistinguishable to the target application location.

In this way, the AF may know if the traffic routing requirements are satisfied and determine whether to accept or reject the selection of the application location. In addition, the privacy of the devices may be protected. The TCF may send the first notification and/or the second notification before or after a first data plane path is configured for connecting the first device to the first target application location. The first data plane path will be used to route the application traffic originated from the first device to the first target application location. The first data plane path may be selected according to the target application location.

In another possible implementation, the first notification includes at least one of: information about the at least one first device; a second address corresponding to the at least one first device; or a second port number corresponding to the at least one first device. In this way, the AF may know which devices are connected to the target application location. In addition, the AF may know the translated source address and translated port number of the at least one first device.

In another possible implementation, the second notification includes at least one of: the information about the at least one first device; the second address corresponding to the at least one first device; or the second port number corresponding to the at least one first device. In this way, the AF may know which devices are connected to the target application location. In addition, the AF may know the translated source address and translated port number of the at least one first device.

In a possible implementation, the first notification and the second notification are a same notification. In this way, the AF may know if the traffic routing requirements are satisfied and determine whether to accept or reject the selection of the application location. In this way, since the second notification indicates whether the source of the traffic originated from the at least one first device is indistinguishable to the target application location, the privacy of the devices may be protected.

In a possible implementation, the first notification further indicates a type of the first notification; and/or the second notification further indicates a type of the second notification. For example, the types of the first/second notification may include "early notification" and "late notification". Early notifications are sent before a data plane path management event, and late notifications are sent after a data plane path management event.

In a possible implementation, the method further includes: sending a synchronization indication to a traffic coordination function (TCF) network entity, wherein the synchronization indication requests the TCF network entity to send a third notification to the at least one first device, the third notification indicates whether the number of the devices whose traffic is routed to the target application location is greater than or equal to the value and/or whether the source of the traffic originated from the at least one first device is indistinguishable to the target application location.

In this way, the at least one first device may know if the traffic routing requirements are satisfied, then the at least one first device may decide to start or stop the traffic accordingly.

In a possible implementation, the method further includes: sending a synchronization indication to a traffic coordination function (TCF) network entity, wherein the synchronization indication requests the TCF network entity to send a third notification to the at least one first device in a case where the number of the devices whose traffic is routed to the target application location is less than or equal to the value and/or in a case where the source of the traffic originated from the at least one first device is distinguishable to the target application location, and the third notification requests the at least one first device to stop the traffic; and/or the synchronization indication requests the TCF network entity to send a fourth notification to the at least one first device in a case where the number of devices whose traffic is routed to the target application location is greater than or equal to the value and/or in a case where the source of the traffic originated from the at least one first device is indistinguishable to the target application location, and the fourth notification requests the at least one first device to start the traffic.

In this case, the at least one first device may stop the traffic (i.e., application traffic) according to the third notification in the case where the traffic routing requirements are dissatisfied. In addition, the at least one first device may (re)start the traffic (i.e., application traffic) according to the fourth notification in the case where the traffic routing requirements are satisfied. In this way, data transmission efficiency may be enhanced, and privacy protection may be ensured.

In a possible implementation, sending the first information about traffic routing requirements to the PCF network entity includes: sending the first information about traffic routing requirements to the PCF network entity via a target network entity. In this case, the AF sends the first information about traffic routing requirements to the PCF indirectly.

In a possible implementation, the target network entity includes a network exposure function (NEF) network entity and/or a network storage function (NSF) network entity. In this case, the AF sends the first information about traffic routing requirements to the PCF indirectly through the NEF and/or the NSF.

According to a second aspect, a method performed by a policy control function (PCF) network entity is provided. The method includes: receiving first information about traffic routing requirements from an application function (AF) network entity, wherein the first information about traffic routing requirements includes: a first indication indicating a value, wherein the first indication indicates that a number of devices whose traffic is to be routed to a target application location is greater than or equal to the value, and the target application location is to receive the traffic from at least one first device; and/or a second indication indicating that a source of the traffic originated from the at least one first device is to be indistinguishable to the target application location; and sending second information indicating the traffic routing requirements to a traffic coordination function (TCF) network entity, wherein the second information is generated based on the first information about traffic routing requirements.

In this case, the PCF may generate the second information indicating the traffic routing requirements according to the first information about traffic routing requirements received from the AF. After that, the PCF may send the second information to the TCF such that the TCF may select the first target application location as the target application location for the first device. Likewise, the TCF may select application locations for other devices. In this way, appropriate application locations may be selected for different devices according to the first information about traffic routing requirements. According to the first information about traffic routing requirements, traffic (i.e., the application traffic) originated from different devices may be routed to different application locations instead of being routed to a common application location, thereby improving the traffic routing performance. In addition, the source of the traffic originated from the at least one first device will become indistinguishable to the target application location. In this way, the target application location will not know which device(s) the traffic is originated from, thereby achieving privacy protection.

In a possible implementation, sending the second information indicating the traffic routing requirements to the TCF network entity includes: sending one or more policies to the TCF network entity, wherein the one or more policies include the second information, and the one or more policies are generated based on the first information about traffic routing requirements.

In a possible implementation, the second indication indicates that the source of the traffic originated from the at least one first device is to be identified by a same address. In this way, the source of the traffic originated from the at least one first device will become indistinguishable to the target application location, thereby achieving privacy protection of the devices.

In another possible implementation, the first information about traffic routing requirements further includes at least one of: device information about one or more devices, wherein the at least one first device belongs to the one or more devices; application location information about one or more application locations, wherein the one or more application locations include the target application location; or traffic information about traffic originated from the one or more devices.

In this case, the one or more devices whose traffic (i.e., application traffic) is to be routed may be identified by the device information. The first target application location may be selected from the application locations that are identified by the application location information. Traffic originated from the one or more devices that need to be routed is identified by the traffic information.

In another possible implementation, the device information about the at least one first device includes at least one of: a first address of each of the at least one first device, a first identifier (ID) of each of the at least one first device, a common address for the at least one first device, or a common ID for the at least one first device.

In another possible implementation, the first information about traffic routing requirements further includes subscription information indicating subscription of one or more notifications, and each notification indicates whether the number of the devices whose traffic is routed to the target application location is greater than or equal to the value, and/or whether the source of the traffic originated from the at least one first device is indistinguishable to the target application location.

In this way, the AF may subscribe to the notifications of the events about the traffic routing requirements, and thus may know if the traffic routing requirements are satisfied.

In another possible implementation, the one or more policies further include a second address corresponding to the at least one first device and/or a second port number corresponding to the at least one first device. In this way, the AF may know which devices are connected to the target application location. In addition, the AF may know the translated source address and translated port number of the at least one first device.

In another possible implementation, receiving the first information about traffic routing requirements from the AF network entity includes: receiving the first information about traffic routing requirements from the AF network entity via a target network entity. In this case, the PCF receives the first information about traffic routing requirements from the AF indirectly.

In another possible implementation, the target network entity includes a network exposure function (NEF) network entity and/or a network storage function (NSF) network entity. In this case, the PCF receives the first information about traffic routing requirements from the AF indirectly through the NEF and/or the NSF.

According to a third aspect, a method performed by a traffic coordination (TCF) network entity is provided. The method includes: receiving second information indicating traffic routing requirements from a policy control function (PCF) network entity, wherein the second information indicating traffic routing requirements includes: a first indication indicating a value, wherein the first indication indicates that a number of devices whose traffic is to be routed to a target application location is greater than or equal to the value, and the target application location is to receive the traffic from at least one first device; and/or a second indication indicating that a source of the traffic originated from the at least one first device is to be indistinguishable to the target application location; and obtaining the target application location from one or more application locations, for the at least one first device, based on the second information.

Therefore, the TCF may select the target application location for the first device according to the second information indicating traffic routing requirements. Likewise, the TCF may select application locations for other devices. In this way, appropriate application locations may be selected for different devices according to the second information about traffic routing requirements that includes the constraint information associated to traffic routing. According to the second information about traffic routing requirements, traffic (i.e., the application traffic) originated from different devices may be routed to different application locations instead of being routed to a common application location, thereby improving the traffic routing performance. In addition, the source of the traffic originated from the at least one first device will become indistinguishable to the target application location. In this way, the target application location will not know which device(s) the traffic is originated from, thereby achieving privacy protection.

In a possible implementation, receiving the second information indicating the traffic routing requirements from the PCF network entity includes: receiving one or more policies from the PCF network entity, wherein the one or more policies include the second information.

In a possible implementation, the second indication indicates that the source of the traffic originated from the at least one first device is to be identified by a same address. In this way, the source of the traffic originated from the at least one first device will become indistinguishable to the target application location, thereby achieving privacy protection of the devices.

In another possible implementation, the second information further includes at least one of: device information about one or more devices, wherein the at least one first device belongs to the one or more devices; application location information about one or more application locations; or traffic information about traffic originated from the one or more devices.

In this case, the one or more devices whose traffic (i.e., application traffic) is to be routed may be identified by the device information. The first target application location may be selected from the application locations that are identified by the application location information. Traffic originated from the one or more devices that need to be routed is identified by the traffic information.

In another possible implementation, the device information about the at least one first device includes at least one of: a first address of each of the at least one first device, a first identifier (ID) of each of the at least one first device, a common address for the at least one first device, or a common ID for the at least one first device.

In another possible implementation, the second information further includes subscription information indicating subscription of one or more notifications, and each notification indicates whether the number of the devices whose traffic is routed to the target application location is greater than or equal to the value, and/or whether the source of the traffic originated from the at least one first device is indistinguishable to the target application location.

In this way, the AF may subscribe to the notifications of the events about the traffic routing requirements, and thus may know if the traffic routing requirements are satisfied.

In a possible implementation, the method further includes: sending a first notification to the AF network entity according to the subscription information, wherein the first notification indicates whether the number of the devices whose traffic is routed to the target application location is greater than or equal to the value; and/or sending a second notification to the AF network entity according to the subscription information, wherein the second notification indicates whether the source of the traffic originated from the at least one first device is indistinguishable to the target application location.

In this way, the AF may know if the traffic routing requirements are satisfied and determine whether to accept or reject the selection of the application location. In addition, the privacy of the devices may be protected. The TCF may send the first notification and/or the second notification before or after a first data plane path is configured for connecting the first device to the first target application location. The first data plane path will be used to route the application traffic originated from the first device to the first target application location. The first data plane path may be selected according to the target application location for data plane efficiency. In this way, the AF may know if the traffic routing requirements are satisfied and determine whether to accept or reject the selection of the application location.

In a possible implementation, the first notification includes at least one of: information about the at least one first device; a second address corresponding to the at least one first device; or a second port number corresponding to the at least one first device. In this way, the AF may know which devices are connected to the target application location. In addition, the AF may know the translated source address and translated port number of the at least one first device.

In another possible implementation, the second notification includes at least one of: the information about the at least one first device; the second address; or the second port number. In this way, the AF may know which devices are connected to the target application location. In addition, the AF may know the translated source address and translated port number of the at least one first device.

In another possible implementation, the method further includes: sending a third notification to the at least one first device, wherein the third notification indicates whether the number of the devices whose traffic is routed to the target application location is greater than or equal to the value and/or whether the source of the traffic originated from the at least one first device is indistinguishable to the target application location.

In this way, the at least one first device may know if the traffic routing requirements are satisfied, then the at least one first device may decide to start or stop the traffic accordingly.

In another possible implementation, the method further includes: sending a third notification to the at least one first device in a case where the number of the devices whose traffic is routed to the target application location is less than the value and/or in a case where the source of the traffic originated from the at least one first device is distinguishable to the target application location, wherein the third notification requests the at least one first device to stop the traffic.

In this case, the at least one first device may stop the traffic (i.e., application traffic) according to the third notification in the case where the traffic routing requirements are dissatisfied. In this way, data transmission efficiency may be enhanced, and privacy protection may be ensured.

In another possible implementation, the method further includes: receiving a synchronization indication from the AF network entity; and sending the third notification to the at least one first device according to the synchronization indication.

In another possible implementation, the method further includes: obtaining capability information of the at least one first device, wherein the capability information indicates that the at least one first device is supportive of the third notification; and sending the third notification to the at least one first device according to the capability information of the at least one first device.

In this way, the TCF may send the third notification if the capability information indicates that the device supports the third notification, and otherwise may not send the third notification.

In another possible implementation, the method further includes: sending a fourth notification to the at least one first device in a case where the number of the devices whose traffic is routed to the target application location is greater than or equal to the value and/or in a case where the source of the traffic originated from the at least one first device is indistinguishable to the target application location, wherein the fourth notification requests the at least one first device to start the traffic.

In this case, the at least one first device may (re)start the traffic (i.e., application traffic) according to the fourth notification in the case where the traffic routing requirements are satisfied. In this way, data transmission efficiency may be enhanced, and privacy protection may be ensured.

In another possible implementation, the method further includes: receiving the synchronization indication from the AF network entity; and sending the fourth notification to the at least one first device according to the synchronization indication.

In another possible implementation, the method further includes: obtaining the capability information of the at least one first device, wherein the capability information indicates that the at least one first device is supportive of the fourth notification; and sending the fourth notification to the at least one first device according to the capability information of the at least one first device.

In this way, the TCF may send the fourth notification if the capability information indicates that the device supports the fourth notification, and otherwise may not send the fourth notification.

In another possible implementation, the method further includes: sending one or more first rules to a first network entity, wherein the first network entity belongs to a data plane path, the data plane path is used for routing the traffic from the first device to the target application location, and the one or more first rules instruct the first network entity to translate the first address of the first device to the second address in a case where the traffic is routed from the first device to the target application location. In other words, the first network entity translates source address of traffic originated from the first device from the first address to the second address.

In this case, the source of the traffic originated from the at least one first device will be identified by a same address (i.e., the second address). In this way, the source of the traffic originated from the at least one first device will become indistinguishable to the target application location, thereby achieving privacy protection of the devices.

In another possible implementation, the one or more first rules further instruct the first network entity to translate a first port number of the first device to the second port number, and the first port number is an original port number of the first device.

In this way, the port number of the at least one first device will become indistinguishable to the target application location, thereby further enhancing privacy protection of the devices.

In a possible implementation, the second address is determined by at least one of the PCF network entity, the TCF network entity or the first network entity.

In a possible implementation, the method further includes: sending one or more second rules to a second network entity, wherein the second network entity belongs to the data plane path, and the one or more second rules instruct the second network entity to translate the second address to the first address of the first device in a case where the traffic is transported from the target application location toward the first device. In other words, the second network entity translates destination address of traffic originated from the first device from the first address to the second address.

In this case, the second network entity performs destination address translation in the case where the traffic is transported from the target application location toward the first device. In this way, the traffic will be routed to the corresponding devices according to the original address (e.g., network address) of the devices.

In another possible implementation, the one or more second rules further instruct the second network entity to translate the second port number to the first port number of the first device. In this way, the traffic will be routed to the corresponding access process of the devices according to the original port number of the devices.

In another possible implementation, the first network entity and the second network entity are a same network entity.

In another possible implementation, the one or more first rules include the first address of the first device and/or the second address; and/or the one or more second rules include the first address of the first device and/or the second address.

In this way, the first network entity may know which traffic it needs to perform source/destination address translation on, and may know which address it needs to translate the original address into. As a result, the source of the traffic originated from the at least one first device will be indistinguishable to the target application location. Likewise, the first network entity may know how to translate the translated address back into the original address, so that the traffic can be transported back to the devices accurately.

In another possible implementation, the one or more first rules further instruct the first network entity to translate a first port number of the first device to the second port number in the case where the traffic is routed from the first device to the target application location.

In this way, the port number of the at least one first device will become indistinguishable to the target application location, thereby further enhancing privacy protection of the devices.

In another possible implementation, the second port number is determined by at least one of the PCF network entity, the TCF network entity or the first network entity.

In another possible implementation, the one or more second rules further instruct the second network entity to translate the second port number to the first port number of the first device in the case where the traffic is transported from the target application location toward the first device.

In this way, the traffic will be routed to the corresponding access process of the devices according to the original port number of the devices.

In another possible implementation, the TCF network entity is integrated with the PCF network entity.

As a result, the functionalities of the PCF will be enhanced.

According to a fourth aspect, a method performed by a device is provided. The method includes: receiving a notification from a traffic coordination function (TCF) network entity, wherein the notification indicates whether a number of devices whose traffic is routed to a target application location is greater than or equal to a value and/or whether a source of the traffic originated from at least one device is indistinguishable to the target application location; stopping traffic according to the notification in a case where the number of the devices whose traffic is routed to the target application location is less than the value and/or in a case where the source of the traffic originated from the at least one device is distinguishable to the target application location; and/or starting the traffic according to the notification in a case where the number of the devices whose traffic is routed to the target application location is greater than or equal to the value and/or in a case where the source of the traffic originated from the at least one device is indistinguishable to the target application location.

In this case, the at least one first device may stop the traffic (i.e., application traffic) according to the third notification in the case where the traffic routing requirements are dissatisfied. In addition, the at least one first device may (re)start the traffic (i.e., application traffic) according to the fourth notification in the case where the traffic routing requirements are satisfied. In this way, data transmission efficiency maybe enhanced, and privacy protection may be ensured.

According to a fifth aspect, a chip is provided. The chip includes a logic circuit and a power supply circuit. The power supply circuit is used to supply power to the logic circuit. The logical circuit is used to execute the steps of the method for traffic routing in one of the first aspect, the second aspect, the third aspect, the fourth aspect or any possible implementation of one of the first aspect, the second aspect, the third aspect, or the fourth aspect.

According to a sixth aspect, a computer device is provided. The computer device includes a storage and a processor. The storage is configured to store a set of computer instructions, and when the set of computer instructions are executed by the processor, the processor executes the steps of the method for traffic routing in one of the first aspect, the second aspect, the third aspect, the fourth aspect or any possible implementation of one of the first aspect, the second aspect, the third aspect or the fourth aspect.

According to a seventh aspect, a communication system is provided. The communication system includes an AF, a PCF a TCF and a device. The AF is used to execute the steps of the method for traffic routing in the first aspect or any possible implementation of the first aspect. The PCF is used to execute the steps of the method for traffic routing in the second aspect or any possible implementation of the second aspect. The TCF is used to execute the steps of the method for traffic routing in the third aspect or any possible implementation of the third aspect. The device is used to execute the steps of the method for traffic routing in the fourth aspect or any possible implementation of the fourth aspect.

According to an eighth aspect, a non-transitory computer-readable storage medium is provided. The non-transitory computer-readable storage medium includes computer software instructions; when computer software instructions are run in a computer device, causing the computer device to execute the steps of the method for traffic routing in one of the first aspect, the second aspect, the third aspect, the fourth aspect or any possible implementation of one of the first aspect, the second aspect, the third aspect, or the fourth aspect.

According to a ninth aspect, a computer program product stored on a non-transitory computer-readable storage medium is provided. The computer program product, when run on the computer, causes the computer to execute the steps of the method for traffic routing in one of the first aspect, the second aspect, the third aspect, the fourth aspect or any possible implementation of one of the first aspect, the second aspect, the third aspect or the fourth aspect.

The advantages brought by any design from the fourth to eighth aspects can be referred to the first aspect, the second aspect, or the third aspect, the fourth aspect or the different designs of the first aspect, the second aspect, the third aspect, and the fourth aspect which will not be detailed here.

On the basis of the implementations provided in the above aspects, the present disclosure is able to provide more implementations by further combination.

### BRIEF DESCRIPTION OF THE DRAWINGS

FIG. 1 shows a communication environment in which embodiments of the present disclosure may be implemented;

FIG. 2 shows another communication environment in which embodiments of the present disclosure may be implemented;

FIG. 3 is a block diagram of a communication system that may be used for implementing devices and methods in accordance with embodiments of the present disclosure;

FIG. 4 shows an apparatus that wirelessly communicates with at least one of two apparatuses in a communication system in accordance with some embodiments of the present disclosure;

FIG. 5 is a block diagram of an ED or apparatus in accordance with some embodiments of the present disclosure;

FIG. 6 shows a conceptual structure of a 6G System in accordance with some embodiments of the present disclosure; and

FIG. 7 shows a signaling chart in accordance with some embodiments of the present disclosure;

FIG. 8 is a flow chart illustrating a method by an application function (AF) network entity in accordance with some embodiments of the present disclosure;

FIG. 9 is a flow chart illustrating a method by a policy control function (PCF) network entity in accordance with some embodiments of the present disclosure;

FIG. 10 is a flow chart illustrating a method by a traffic coordination (TCF) network entity in accordance with some embodiments of the present disclosure; and

FIG. 11 is a flow chart illustrating a method by a device in accordance with some embodiments of the present disclosure.

### DETAILED DESCRIPTION OF THE ILLUSTRATIVE EMBODIMENTS

For illustrative purposes, specific example embodiments will now be explained in greater detail in conjunction with the figures and above mentioned system, core network, ED and TRP.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Principle of the present disclosure will now be described with reference to the embodiments of the present disclosure. It will be understood that these embodiments are described only for the purpose of illustration and to help those skilled in the art understand and implement the present disclosure, without suggesting any limitation as to the scope of the disclosure. Embodiments described herein can be implemented in various manners other than those described below.

References in the present disclosure to "one embodiment", "an embodiment", "an example embodiment", "some embodiments" and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It will be understood that although the terms "first", "second", etc. in front of noun(s) and the like may be used herein to describe various elements; and these elements should not be limited by these terms. These terms are only used to distinguish one element from another and they do not limit the order of the noun(s). For example, a first element could be termed a second element, and similarly, a second element could be termed a first element, without departing from the scope of the embodiments. As used herein, the term "and/or" includes any and all combinations of one or more of the listed terms.

As used herein, "at least one of: <a list of two or more elements>" and "at least one of <a list of two or more elements>" and similar wording, where the list of two or more elements is joined by "and" or "or", indicate at least any one of the elements, or at least any two or more of the elements, or at least all the elements.

The terminology used herein is for the purpose of describing particular embodiments only and is not intended to be limiting of example embodiments. As used herein, the singular forms "a", "an" and "the" are intended to include the plural forms as well, unless the context clearly indicates otherwise. It will be further understood that the terms "comprises", "comprising", "has", "having", "includes" and/or "including", when used herein, specify the presence of stated features, elements, and/or components etc., but do not preclude the presence or addition of one or more other features, elements, components and/or combinations thereof.

As used herein, the term "communication network" refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), and Narrow Band Internet of Things (NB-IoT). Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term "network device" refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some embodiments, a radio access network (RAN) split architecture includes a Centralized Unit (CU) and a Distributed Unit (DU) at an IAB donor node. An IAB node includes a Mobile Terminal (IAB-MT) part that behaves like a UE toward the parent node, and a DU part of an IAB node behaves like a base station toward the next-hop IAB node.

The term "terminal device" refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IoT) device, a watch or other wearables, a head-mounted display (HMD), a vehicle, a drone, a medical device and application (e.g., remote surgery), an industrial device and application (e.g., a robot and/or other wireless devices operating in an industrial and/or an automated processing chain context), a consumer electronics device, a device operating on commercial and/or industrial wireless networks, and the like. The terminal device may also correspond to a Mobile Termination (MT) part of an IAB node (e.g., a relay node). In the following description, the terms "terminal device", "communication device", "terminal", "user equipment" and "UE" may be used interchangeably.

FIG. 1 illustrates an example communication environment in which example embodiments of the present disclosure can be implemented. Referring to FIG. 1, as an illustrative example without limitation, a simplified schematic illustration of a communication system (also referred to as computing and communications environment) 100 is provided. The communication system 100 (which may be a wireless system) comprises a radio access network (RAN) 120. The RAN 120 may be a next generation (e.g. sixth generation (6G) or later) radio access network, or a legacy (e.g. 5G, 4G, 3G or 2nd generation (2G)) radio access network. One or more communication electronic device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system 100 and may be dependent or independent of the radio access technology used in the communication system 100. The communication system 100 may also comprise a public switched telephone network (PSTN) 140, the internet 150, and other networks 160.

In general, the communication system 100 enables multiple wireless or wired elements to communicate data and other content. The communication system 100 may provide content, such as voice, data, video, and/or text, via broadcast, multicast, groupcast, unicast, etc. And the communication system 100 may provide a wide range of communication services and applications (such as earth monitoring, remote sensing, passive sensing and positioning, navigation and tracking, autonomous delivery and mobility, etc.) The services and/or applications may be mobile broadband (MBB) services, ultra-reliable low-latency communication (URLLC) services, or machine type communication (MTC) services.

The communication system 100 may operate by sharing resources, such as carrier spectrum bandwidth, between its constituent elements.

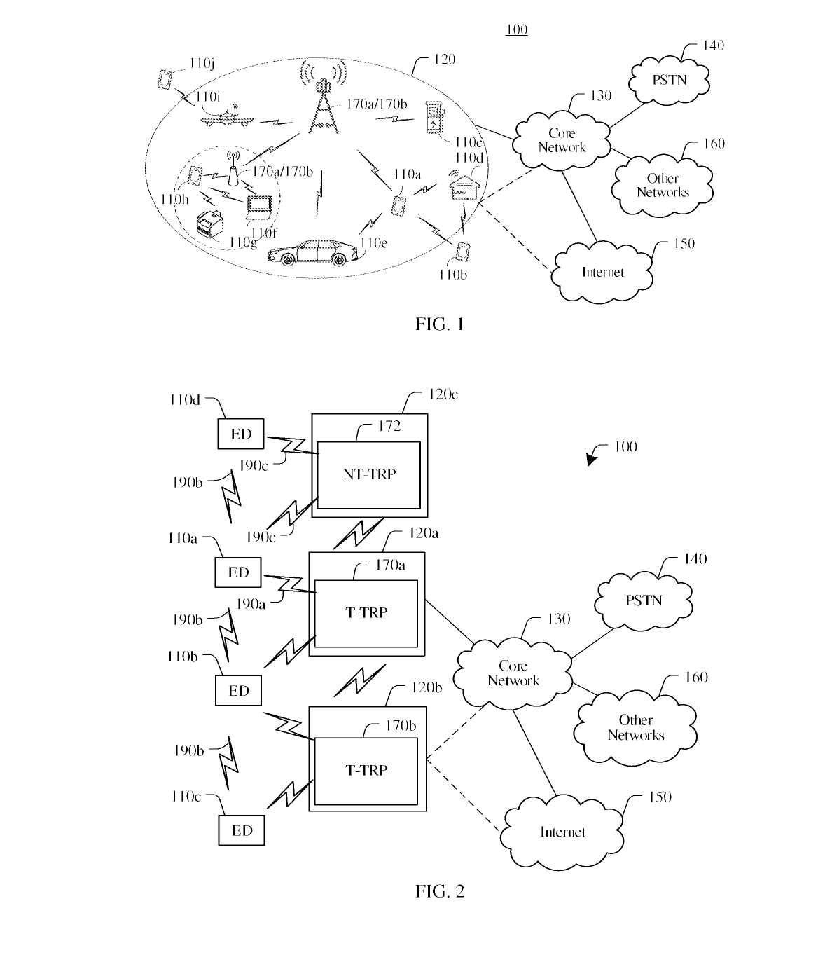

FIG. 2 illustrates another example communication environment in which example embodiments of the present disclosure can be implemented.

The communication system 100 may include a terrestrial communication system 120a/120b and/or a non-terrestrial communication system 120c. The communication system 100 may provide a high degree of availability and robustness through a joint operation of a terrestrial communication system 120a/120b and a non-terrestrial communication system 120c. For example, integrating a non-terrestrial communication system 120c (or components thereof) into a terrestrial communication system 120a/120b can result in what may be considered a heterogeneous network comprising multiple layers. The heterogeneous network may achieve better overall performance through efficient multi-link joint operation, more flexible functionality sharing, and faster physical layer link switching between terrestrial networks and non- terrestrial networks.

The terrestrial communication system 120a/120b and the non-terrestrial communication system 120c could be considered sub-systems of the communication system.

The communication system 100 may include ED 110a, 110b, 110c, 110d (generically referred to as ED 110), and RAN 120a, 120b. In addition, the communication system 100 may also include a non-terrestrial communication network 120c. The communication system 100 may also include one or more of a core network 130, a public switched telephone network (PSTN) 140, the Internet 150, and other networks 160. The RANs 120a, 120b include respective RAN nodes such as base stations (BSs) 170a, 170b, which may be generically referred to as terrestrial transmit and receive points (T-TRPs) 170a, 170b (generically referred to as T-TRP 170). In one implementation, the non-terrestrial communication network 120c includes a RAN node such as an access node (or base station) 172, which may be generically referred to as a non-terrestrial transmit and receive point (NT-TRP) 172. As may be surmised on the basis of similarity in reference numerals, the non-terrestrial communication network 120c may be considered to be a radio access network, with operational aspects in common with the RANs 120a, 120b. In another implementations, the non-terrestrial communication network 120c may include at least one non-terrestrial network (NTN) device and at least one corresponding terrestrial network device, wherein the at least one non-terrestrial network device works as a transport layer device and the at least one corresponding terrestrial network device works as a RAN node, which communicates with the ED 110 via the non-terrestrial network device. In addition, there may be a NTN gateway in the ground (i.e., referred as a terrestrial network device) also as a transport layer device to communication with both the NTN device, and the RAN node communicates with the ED 110 via the NTN device and the NTN gateway. In some embodiments, the NTN gateway and the RAN node may be located in the same device.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, ED 110a may communicate an uplink (UL) and/or downlink (DL) transmission over a terrestrial air interface 190a with T-TRP 170a. In some examples, the EDs 110a, 110b, 110c, and 110d may also communicate directly with one another via one or more sidelink (SL) air interfaces 190b. In some examples, ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA, also known as discrete Fourier transform spread OFDMA, DFT-s-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or more NT-TRPs 172 via a wireless link or simply a link. For some examples, the link is a dedicated connection for unicast transmission, a connection for broadcast transmission, or a connection between a group of EDs 110 and one or more NT-TRPs 172 for multicast transmission.

The RANs 120a and 120b are in communication with the core network 130 to provide the EDs 110a110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a110b, and 110c or both, and (ii) other networks (such as the PSTN 140, the Internet 150, and the other networks 160). In addition, some or all of the EDs 110a110b, and 110c may include functionality for communicating with different wireless networks over different wireless links using different wireless technologies and/or protocols. Instead of wireless communication (or in addition thereto), the EDs 110a110b, and 110c may communicate via wired communication channels to a service provider or switch (not shown), and to the Internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a110b, and 110c may be multimode devices capable of operation according to multiple radio access technologies, and incorporate multiple transceivers necessary to support such.

In addition, the communication system 100 may comprise a sensing agent (not shown in the figure) to manage the sensed data from ED110 and or the T-TRP 170 and/or NT-TRP 172. In one implementation, the sensing agent is located in the T-TRP 170 and/or NT-TRP 172. In another implementation, the sensing agent is a separate node which has interface to communicate with the core network 130 and/or the RAN 120 (e.g., the T-TRP 170 and/or NT-TRP 172).

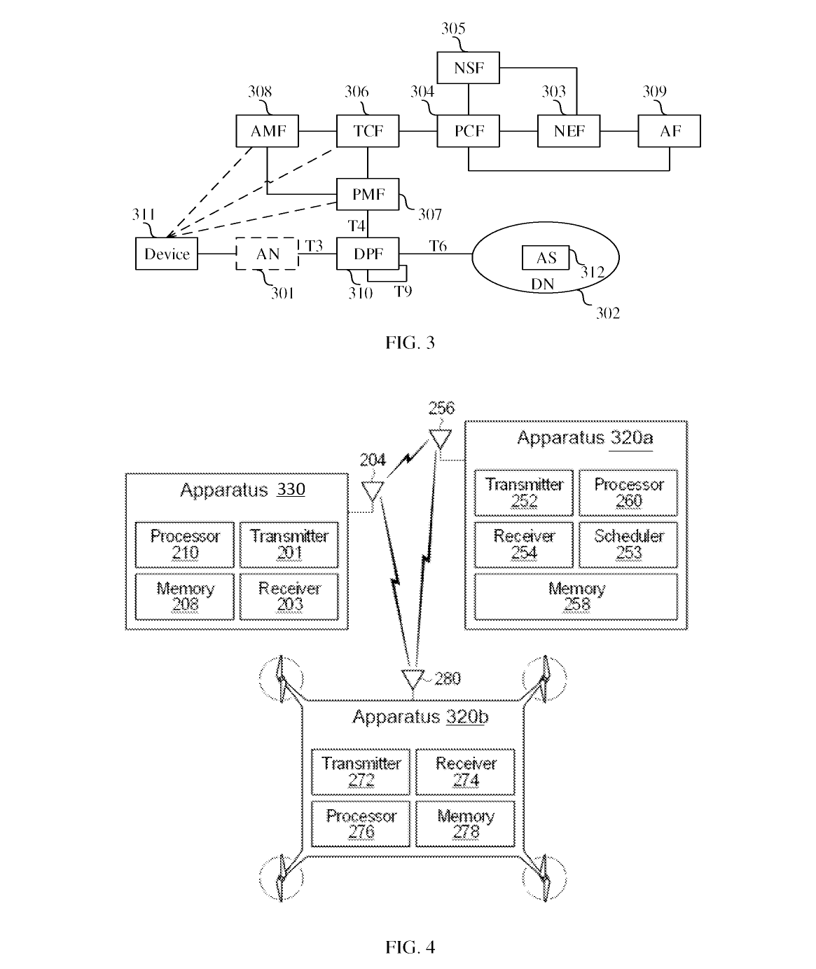

FIG. 3 is an example block diagram of a communication system 100 that may be used for implementing devices and methods in accordance with representative embodiments of the present disclosure.

As illustrated in FIG. 3, the communication system 100 considered in this disclosure includes a device, an access network (AN) 301, a core network (CN) 130 (not shown in FIG. 3) and a data network (DN) 302.

The CN 130 includes a control plane and a data plane. The control plane includes at least one of control plane functions (CPFs): a network exposure function (NEF) 303, a policy control function (PCF) 304, a network storage function (NSF) 305, a traffic coordination function (TCF) 306 and a path management function (PMF) 307. In some embodiments, the control plane further includes another CPF, i.e. an access and mobility management function (AMF) 308. The data plane includes a data plane function (DPF). In some embodiments, the data plane is known as user plane.

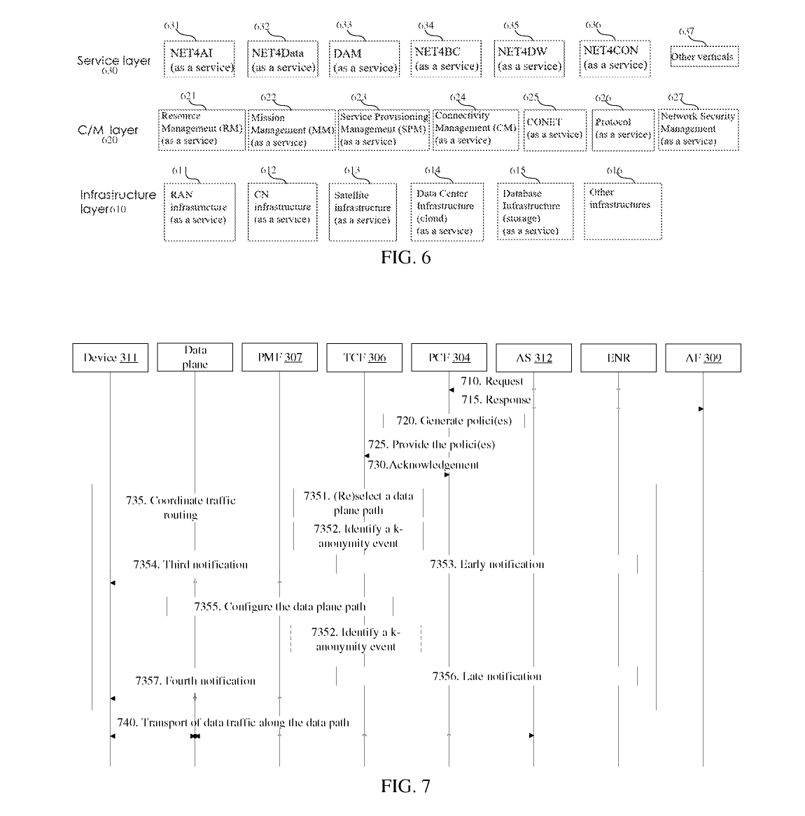

The system further includes an application function (AF) 309, as illustrated in FIG. 6. The AF 309 interacts with the control plane of the CN 130 in order to access or provide services. In some embodiments, for example, when the AF 309 is located in a trust domain, the AF 309 is allowed to interact directly with relevant control plane functions, e.g. the NSF 305, the PCF 304. In some embodiments, for example, when the AF 309 is not located in a trust domain, the AF 309 is not allowed to interact directly with the control plane functions, but via the NEF 303. Without ambiguity, AF and AF network entity are used interchangeably for ease of presentation unless clarified.

The functionalities of the CPFs and the DPF 310 are as described below.

AMF 308: The AMF 308 may implement functionalities the same as or similar to those of the AMF in the 3GPP 5G system, e.g. registration management, connection management, reachability management, mobility Management, access authentication, access authorization, etc., as described in 3GPP TS 23.501 V18.2.0. In some embodiments, the AMF 308 corresponds to the AMF in the 3GPP 5G system (i.e. 5G AMF in short).

NEF 303: The NEF 303 may implement at least one of functionalities, for example, but not limited to: exposure of network information, analytics, capabilities and events, secure provision of information from external application (e.g. AF) to the system, and translation of internal-external information, etc. In some embodiments, the NEF 303 corresponds to the NEF in the 3GPP 5G system. Without ambiguity, NEF and NEF network entity are used interchangeably for ease of presentation unless clarified.

PCF 304: The PCF 304 may implement at least one of functionalities, for example, but not limited: support of unified policy framework to govern network behavior, making policy decisions and providing resultant policy rules to control plane function(s) to enforce them, accessing subscription information and application data relevant for policy decisions in one or more network storage functions (e.g. NSF). In some embodiments, the PCF 304 corresponds to the PCF in the 3GPP 5G system. Without ambiguity, PCF and PCF network entity are used interchangeably for ease of presentation unless clarified.

NSF 305: The NSF 305 may implement at least one of functionalities, for example, but not limited: storage and retrieval of subscription data, storage and retrieval of policy data, storage and retrieval of structured data for exposure, storage and retrieval of application data (including Packet Flow Descriptions (PFDs) for application detection, information associated with AF request, device group information for group management), etc. In some embodiments, the NSF 305 corresponds to the UDR in the 3GPP 5G system. Without ambiguity, NSF and NSF network entity are used interchangeably for ease of presentation unless clarified.

TCF 306: The TCF 306 makes traffic routing decisions and coordinates traffic routing, as described in this disclosure. In some embodiments, the TCF 306 is integrated with the PMF 307. In some embodiments, the TCF 306 is integrated with the PCF 304. In some embodiments, the TCF 306 is a separate network function, different from the PMF 307 and the PCF 304. The TCF 306 interacts with the device 311 via an interface shown as a dashed line in FIG. 3. When the device 311 is a terminal device, this interface is through the AN 301 and may be viewed as an NAS (Non Access Stratum). In some embodiments, the interface is through one or more other CPFs, e.g. the PMF 307, the AMF 308, the NEF 303, as further described below. Without ambiguity, TCF and TCF network entity are used interchangeably for ease of presentation unless clarified.

PMF 307: The PMF 307 may implement at least one of the following functionalities, for example, but not limited to: selection and control of DPF 310, maintaining/configuring data plane topology or paths, establishing and releasing data plan tunnels, configuring traffic forwarding at DPF 310 to apply local switching or packet forwarding, configures traffic steering at DPF 310 to route traffic to proper destination, etc. The PMF 307 configures a DPF 310 via the T4 interface. In some embodiments, the PMF 307 corresponds to the SMF in the 3GPP 5G system. The PMF 307 may interact with the device 311 via an interface shown as dashed line in FIG. 3. When the device 311 is a terminal device, this interface is through the AN 301 and may be viewed as an NAS (Non Access Stratum) interface. In some embodiments, the interface is through another CPF, e.g. the AMF 308 or the NEF 303, as further described below. Without ambiguity, PMF and PMF network entity are used interchangeably for ease of presentation unless clarified.

DPF 310: The DPF 310 may implement at least one of functionalities, for example, but not limited: acting as a point of interconnect to the DN 302, acting as an anchor point for a device 311 in the DP, routing/forwarding packets, enforcing policy rules (e.g. traffic gating, redirection, traffic steering), performing traffic marking in the uplink and downlink, performing packet buffering and data notification triggering, performing packet inspection (e.g. application detection). In some embodiments, the data plane corresponds to the user plane of the 3GPP 5G system, and the DPF 310 corresponds to the UPF in the 3GPP 5G system.

The CPFs and the DPF 310 described above are logical network functions. Each of the CPFs and the DPF 310 can be instantiated at one or more network locations, resulting in one or more instances. When the AN 301 (e.g. an AN node) implements functionalities of a logical network function (any of the control plane functions and the DPF 310), it is considered that the logical network function is instantiated in the AN 301 (e.g. at the AN node). A network location may refer to a data center or an AN node. There may be more than one instances of a logical network function at a same network location.

The device 311 is an electronic device (e.g., ED 110 in FIG. 1). If the device 311 is a terminal device such as a UE, the device 311 connects with the CN 130 (including the control plane and the data plane) via the AN 301: the device 311 is served by an AN node in the AN 301, i.e. having a connection with the AN node, which in turns connects to the CN 130. The device 311 may be a wireless device. If the device 311 is a wireless terminal device, the device 311 connects with the CN 130 via the AN 301, the AN 301 is a radio access network, e.g. the 5G RAN or 6G RAN, the serving AN node of the device 311 (i.e. the AN node serving the device) is a radio access point such as a base station, and the connection between the device 311 and its serving AN node is a wireless connection. In some embodiments, when the device 311 is not a terminal device (e.g. a server, a network entity), the AN 301 is optional, and the device 311 connects with the CN 130 directly.

Connection between the device 311 and the DN 312:

If the device 311 connects with the CN via the AN 301, the device 311 is served by an AN node (e.g., TRP 170 in FIG. 1). The serving AN node of the device 311 connects with the DPF 310 (in face, an instance of the DPF) in the data plane of the CN through a data plane path. The DPF 310 is an anchor point for the device 311 in the data plane and can be referred to as DPA. The data plan path is associated to the device; it includes the serving AN node, the DPA and possibly one or more intermediate DPFs (i.e. other instances of the DPF 310. When one or more intermediate DPFs 310 are included in the data plane path, they are located between the serving AN node. The serving AN node connects either with the DPA or with an intermediate DPF 310 in the data plane path, via the T3 interface. Two adjacent DPF 310 instances (e.g. two intermediate DPFs, or an intermediate DPF and the DPA) in the data plane path are connected via the T9 interface. The DPA connects to the DN 312 via the T6 interface. Hence, the communication system connects the device with the DN 312 via the AN 301 and the data plane of the CN. Through the communication system 100, the device 311 can communicate with an application server (AS) located in the DN 312, for example, send data traffic to and/or receive data traffic from the AS.

Connection between the device 311 and the CN control plane:

A control plane function (CPF), such as the AMF 308, the PMF 307 or the TCF 306, can interact with the device 311 via a first interface, shown as a dashed line in FIG. 3. In some embodiments, the interaction is further through a relay function in the control plane. In this case, when the CPF interacts with the device 311 via the first interface, the CPF interacts with the relay function via a second interface, which in turn interacts with the device 311 with a third interface. For example, when the CPF sends a message to the device 311 via the first interface, the CPF sends the message to the rely function using the second interface, which then forwards the message to the device 311 using the third interface; when the device 311 sends a message to the CPF via the first interface (e.g. the message including the information indicating the device’s capability) to the TCF 306 as described in the step 7351 in FIG. 7, where the TCF 306 is the CPF), the device 311 sends the message to the relay function using the third interface, which then forwards the message to the CPF using the second interface. Before forward the message, the relay function may perform information mapping, wherein the control plane function changes or updates some original information in the message to a mapped information, such that the message includes the mapped information instead of the original information when being forwarded.

Hence, the first interface (between the CPF and the device 311) can be viewed as comprising or implemented through the second interface (between the CPF and the relay function) and the third interface (the relay function and the device 311), and the first interface is said through the relay function. In some embodiments, the first interface and the third interface are the same interface in the view of the device 311. In some embodiments, the first interface and the second interface are the same interface in the view of the CPF. In some embodiments, the first interface, the second interface or the third interface corresponds to a communication tunnel.

When the device 311 is a terminal device such as a UE, the first interface is through the AN 301. If the first interface is implemented through the second interface and the third interfaces, the third interface is through the AN 301, and the first interface is through the AN 301 due to the third interface being through the AN 301. When the relay function forwards the message, the relay function may include the message, or content of the message, in another message and send the other message using the third interface (if the message is from the CPF and targeting the device 311) or the second interface (if the message is from the device 311 and targeting the CPF). If the device 311 is further a wireless device, the first interface and the third interface are NAS (Non Access Stratum) interfaces. A message transmitted using a NAS interface is a NAS message.

When the device 311 is a terminal device such as a UE, the relay function may be:

the PMF 307 or the AMF 308, if the CPF is the TCF 306; or,

the AMF 308, if the CPF is the PMF 307.

Note that the above description about the first interface between the CPF and the device 311, when the device 311 is a terminal device, is recursive and can be applied to the third interface. That is, if the relay function is the PMF 307, the third interface may be through another relay function, e.g. the AMF 308.

When the device 311 is not a terminal device, the relay function may be:

the PMF 307 or the NEF 303, if the CPF is the TCF 306; or,

the NEF 303, if the CPF is the PMF 307.

Note that the above description about the first interface between the CPF and the device 311, when the device 311 is not a terminal device, is recursive and can be applied to the third interface. That is, if the relay function is the PMF 307, the third interface may be through another relay function, e.g. the NEF 303.

FIG. 4 illustrates example of an Apparatus 330 wirelessly communicating with at least one of two apparatuses (e.g., Apparatus 320a and Apparatus 320b, referred as Apparatus 320) in a communication system, e.g., the communication system 100, according to one embodiment. The Apparatus 310 may be a UE (e.g., ED 110 in FIG. 3). The Apparatus 320a may be a terrestrial network device (e.g., T-TRP 170 as shown in FIG. 3), and Apparatus 320b may be a non-terrestrial network device (e.g., NT-TRP 172 as shown in FIG. 3). However, this is not necessary. For example, Apparatus 320a may be a NT-TRP, and 320b may be a T-TRP, both Apparatus 320a and 320b may be T-TRPs or NT-TRPs, according to present disclosure. In the following, the ED 110 as an example of the Apparatus 330 is described, and T-TRP 170 as an example of Apparatus 320a is described, and NT-TRP 172 as an example of Apparatus 320a is described. Although only one Apparatus 330, one Apparatus 320a and one Apparatus 320b Please note that the number of Apparatus 330 (e.g. ED 110) could be one or more, and the number of Apparatus 320a and/or 320b could be one or more. For example, one ED110 may be served by only one T-TRP 170 (or one NT-TRP172), by more than one T-TRP 170, by more than one NT-TRP 172, or by one or more T-TRP 170 and one or more NT-TRP172.

The ED 110 is used to connect persons, objects, machines, etc. The ED 110 may be widely used in various scenarios including, for example, cellular communications, device-to-device (D2D), vehicle to everything (V2X), peer-to-peer (P2P), machine-to-machine (M2M), MTC, internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to but not limited to) as a user equipment/device (UE), a wireless transmit/receive unit (WTRU), a mobile station, a fixed or mobile subscriber unit, a cellular telephone, a station (STA), a MTC device, a personal digital assistant (PDA), a smartphone, a laptop, a computer, a tablet, a wireless sensor, a consumer electronics device, a smart book, a vehicle, a car, a truck, a bus, a train, or an IoT device, wearable devices (such as a watch, a pair of glasses, head mounted equipment, etc.), an industrial device, or an apparatus in (e.g. communication module, modem, or chip) or comprising the forgoing devices, among other possibilities. Future generation EDs 110 may be referred to using other terms. The base station 170a and 170b is a T-TRP and will hereafter be referred to as T-TRP 170. Also shown in FIG. 4, a non-terrestrial (NT) device will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

As shown in FIG. 4, the ED 110 include at least one processor 210. Only one processor 210 is illustrated to avoid congestion in the drawing. The ED 110 may further include a transmitter 201 and a receiver 203 coupled to one or more antennas 204. Only one antenna 204 is illustrated to avoid congestion in the drawing. One, some, or all of the antennas 204 may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals. The ED 110 may include at least one memory 208. Only the transmitter 201, receiver 203, processor 210, memory 208, and antenna 204 is illustrated for simplicity, but the ED 110 may include one or more other components.

The memory 208 stores instructions. The memory 208 may also stores data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 1). The input/output devices or interfaces permit interaction with a user or other devices in the network. Each input/output device or interface includes any suitable structure for providing information to or receiving information from a user, and/or for network interface communications. Suitable structures include, for example, a speaker, microphone, keypad, keyboard, display, touch screen, etc.

The processor 210 performs (or controlling the ED110 to perform) operations described herein as being performed by the ED110. As illustrated below and elsewhere in the present disclosure. For example, the processor 210 performs or controls the ED110 to perform receiving transport blocks (TBs), using a resource for decoding of one of the received TBs, releasing the resource for decoding of another of the received TBs, and/or receiving configuration information configuring a resource. In details, the operation may include those operations related to preparing a transmission for uplink transmission to the NT-TRP 172 and/or the T-TRP 170; those operations related to processing downlink transmissions received from the NT-TRP 172 and/or the T-TRP 170; and those operations related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Processing operations related to processing sidelink transmissions may include operations such as transmit/receive beamforming, modulating/demodulating and encoding/decoding symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g. beam angle information (BAI), received from the T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201, and the processing components of the receiver 203 may each be implemented by the same or different one or more processors that are configured to execute instructions stored in a memory (e.g. in the memory 208). Alternatively, some or all of the processor 210, the processing components of the transmitter 201, and the processing components of the receiver 203 may each be implemented using dedicated circuitry, such as a programmed field-programmable gate array (FPGA), an application-specific integrated circuit (ASIC), or a hardware accelerator such as a graphics processing unit (GPU) or an artificial intelligence (AI) accelerator.

In some embodiments, the ED 110 may an apparatus (also called component) for example, communication module, modem, chip, or chipset, it includes at least one processor 210, and an interface or at least one pin. In this scenario, the transmitter 201 and receiver 203 may be replaced by the interface or at least one pin, wherein the interface or at least one pin is to connect the apparatus (e.g., chip) and other apparatus (e.g., chip, memory, or bus). Accordingly, the transmitting information to the NT-TRP 172 and/or the T-TRP 170 and/or another ED 110 may be referred as transmitting information to the interface or at least one pin, or as transmitting information to the NT-TRP 172 and/or the T-TRP 170 and/or another ED 110 via the interface or at least one pin, and receiving information from the NT-TRP 172 and/or the T-TRP 170 and/or another ED 110 may be referred as receiving information from the interface or at least one pin, or as receiving information from the NT-TRP 172 and/or the T-TRP 170 and/or another ED 110 via the interface or at least one pin. The information may include control signaling and/or data.

As shown in FIG. 4, the T-TRP 170 include at least one processor 260. Only one processor 260 is illustrated to avoid congestion in the drawing. The T-TRP 170 may further include at least one transmitter 252 and at least one receiver 254 coupled to one or more antennas 256. Only one antenna 256 is illustrated to avoid congestion in the drawing. One, some, or all of the antennas 256 may alternatively be panels. The transmitter 252 and the receiver 254 may be integrated as a transceiver. The T-TRP 170 may further include at least one memory 258. The T-TRP 170 may further include scheduler 253. Only the transmitter 252, receiver 254, processor 260, memory 258, antenna 256 and scheduler 253 are illustrated for simplicity, but the T-TRP may include one or more other components.

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro base station (BS), a pico BS, a relay node, a donor node, or the like, or combinations thereof. The T-TRP 170 may refer to the forgoing devices or refer to apparatus (e.g. a communication module, a modem, or a chip) in the forgoing devices.

In some embodiments, the parts of the T-TRP 170 may be distributed. For example, some of the modules of the T-TRP 170 may be located remote from the equipment that houses the antennas 256 for the T-TRP 170, and may be coupled to the equipment that houses the antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses the antennas 256 of the T-TRP 170. The modules may also be coupled to other T-TRPs. In some embodiments, the T-TRP 170 may actually be a plurality of T-TRPs that are operating together to serve the ED 110, e.g. through the use of coordinated multipoint transmissions.

The processor 260 performs operations including those related to: preparing a transmission for downlink transmission to the ED 110, processing an uplink transmission received from the ED 110, preparing a transmission for backhaul transmission to the T-TRP 170 and/or NT-TRP 172, and processing a transmission received over backhaul from the T-TRP 170 and/or NT-TRP 172. Processing operations related to preparing a transmission for downlink or backhaul transmission may include operations such as encoding, modulating, precoding (e.g. multiple input multiple output (MIMO) precoding), transmit beamforming, and generating symbols for transmission. Processing operations related to processing received transmissions in the uplink or over backhaul may include operations such as receive beamforming, demodulating received symbols, and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates an indication of beam direction, e.g. BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252.

The scheduler 253 may be coupled to the processor 260 or integrated in the processor 260. The scheduler 253 may be included within or operated separately from the T-TRP 170. The scheduler 253 may schedule uplink, downlink, sidelink, and/or backhaul transmissions, including issuing scheduling grants and/or configuring scheduling-free (e.g., "configured grant") resources.

The memory 258 is configured to store information, and optionally data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252, and the processing components of the receiver 254 may each be implemented by the same or different one or more processors that are configured to execute instructions stored in a memory, e.g. in the memory 258. Alternatively, some or all of the processor 260, the scheduler 253, the processing components of the transmitter 252, and the processing components of the receiver 254 may be implemented using dedicated circuitry, such as a programmed FPGA, a hardware accelerator (e.g., a GPU or AI accelerator), or an ASIC.

When the T-TRP 170 is an apparatus (also called as component, for example, communication module, modem, chip, or chipset in a device, it includes at least one processor, and an interface or at least one pin. In this scenario, the transmitter 252 and receiver 254 may be replaced by the interface or at least one pin, wherein the interface or at least one pin is to connect the apparatus (e.g., chip) and other apparatus (e.g., chip, memory, or bus). Accordingly, the transmitting information to the NT-TRP 172 and/or the T-TRP 170 and/or ED 110 may be referred as transmitting information to the interface or at least one pin, and receiving information from the NT-TRP 172 and/or the T-TRP 170 and/or ED 110 may be referred as receiving information from the interface or at least one pin. The information may include control signaling and/or data.

Although the NT-TRP 172 is illustrated as a drone only as an example, the NT-TRP 172 may be implemented in any suitable non-terrestrial form, such as satellites and high altitude platforms, including international mobile telecommunication base stations and unmanned aerial vehicles, for example. Also, the NT-TRP 172 may be known by other names in some implementations, such as a non-terrestrial node, a non-terrestrial network device, or a non-terrestrial base station.

As shown in FIG. 4, The T-TRP 170 may further include at least one transmitter 252 and at least one receiver 254 coupled to one or more antennas 256. Only one antenna 256 is illustrated to avoid congestion in the drawing. One, some, or all of the antennas 256 may alternatively be panels. The transmitter 252 and the receiver 254 may be integrated as a transceiver. The T-TRP 170 may further include at least one memory 258. The T-TRP 170 may further include scheduler 253. Only the transmitter 252, receiver 254, processor 260, memory 258, antenna 256 and scheduler 253 are illustrated for simplicity, but the T-TRP may include one or more other components.

As shown in FIG. 4, the NT-TRP 172 include at least one processor 276. Only one processor 276 is illustrated to avoid congestion in the drawing. The NT-TRP 172 may include a transmitter 272 and a receiver 274 coupled to one or more antennas 280. Only one antenna 280 is illustrated to avoid congestion in the drawing. One, some, or all of the antennas may alternatively be panels. The transmitter 272 and the receiver 274 may be integrated as a transceiver. The NT-TRP 172 may further include at least one memory 278. The NT-TRP 172 may further include scheduler. Only the transmitter 272, receiver 274, processor 276, memory 278, antenna 280 are illustrated for simplicity, but the NT-TRP may include one or more other components.

The NT-TRP 172 include a processor 276 for performing operations including those related to: preparing a transmission for downlink transmission to the ED 110, processing an uplink transmission received from the ED 110, preparing a transmission for backhaul transmission to T-TRP 170 and/or another NT-TRP 172, and processing a transmission received over backhaul from the T-TRP 170 and/or another NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating received symbols, and decoding received symbols. In some embodiments, the processor 276 implements the transmit beamforming and/or receive beamforming based on beam direction information (e.g. BAI) received from the T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The memory 278 is configured to store information and optionally data. The memory 258 stores instructions and data used, generated, or collected by the NT-TRP 172. For example, the memory 278 could store software instructions or modules configured to implement some or all of the functionality and/or embodiments described herein and that are executed by the processor 276.

Although not illustrated, the processor 276 may form part of the transmitter 272 and/or part of the receiver 274. Although not illustrated, the memory 278 may form part of the processor 276.

The processor 276, the processing components of the transmitter 272, and the processing components of the receiver 274 may each be implemented by the same or different one or more processors that are configured to execute instructions stored in a memory, e.g. in the memory 278. Alternatively, some or all of the processor 276, the processing components of the transmitter 272, and the processing components of the receiver 274 may be implemented using dedicated circuitry, such as a programmed FPGA, a hardware accelerator (e.g., a GPU or AI accelerator), or an ASIC. In some embodiments, the NT-TRP 172 may actually be a plurality of NT-TRPs that are operating together to serve the ED 110, e.g. through coordinated multipoint transmissions.

When the NT-TRP 172 is an apparatus (e.g. communication module, modem, chip, or chipset) in a device, it includes at least one processor, and an interface or at least one pin. In this scenario, the transmitter 272 and receiver 257 may be replaced by the interface or at least one pin, wherein the interface or at least one pin is to connect the apparatus (e.g., chip) and other apparatus (e.g., chip, memory, or bus). Accordingly, the transmitting information to the T-TRP 170 and/or another NT-TRP 172 and/or ED 110 may be referred as transmitting information to the interface or at least one pin, and receiving information from the T-TRP 170 and/or another NT-TRP 172 and/or ED 110 may be referred as receiving information from the interface or at least one pin. The information may include control signaling and/or data.

Note that "TRP", as used herein, may refer to a T-TRP or a NT-TRP. A T-TRP may alternatively be called a terrestrial network TRP ("TN TRP") and a NT-TRP may alternatively be called a non-terrestrial network TRP ("NTN TRP").The T-TRP 170, the NT-TRP 172, and/or the ED 110 may include other components, but these have been omitted for the sake of clarity.

Note that "signaling", as used herein, may alternatively be called control signaling, control message, control information, or message for simplicity. Signaling between a BS (e.g., the network node 170) and a terminal or sensing device (e.g., ED 110), or signaling between different terminal or sensing device (e.g., between ED 110i and ED110j) may be carried in physical layer signaling (also called as dynamic signaling), which is transmitted in a physical layer control channel. For downlink the physical layer signaling may be known as downlink control information (DCI) which is transmitted in a physical downlink control channel (PDCCH). For uplink, the physical layer signaling may be known as uplink control information (UCI) which is transmitted in a physical uplink control channel (PUCCH). For sidelink, signaling between different terminal or sensing device (e.g., between ED 110i and ED110j) may be known as sidelink control information (SCI) which is transmitted in a physical sidelink control channel (PSCCH). Signaling may be carried in a higher-layer (e.g., higher than physical layer) signaling, which is transmitted in a physical layer data channel, e.g. in a physical downlink shared channel (PDSCH) for downlink signaling, in a physical uplink shared channel (PUSCH) for uplink signaling, and in a physical sidelink shared channel (PSSCH) for sidelink signaling. Higher-layer signaling may also called static signaling, or semi-static signaling. Higher-layer signaling may be radio resource control (RRC) protocol signaling or media access control – control element (MAC-CE) signaling. Signaling may be included in a combination of physical layer signaling and higher layer signaling.

It should be noted that in present disclosure, "information", when different from "message", may be carried in one single message, or be carried in more than one separate message.

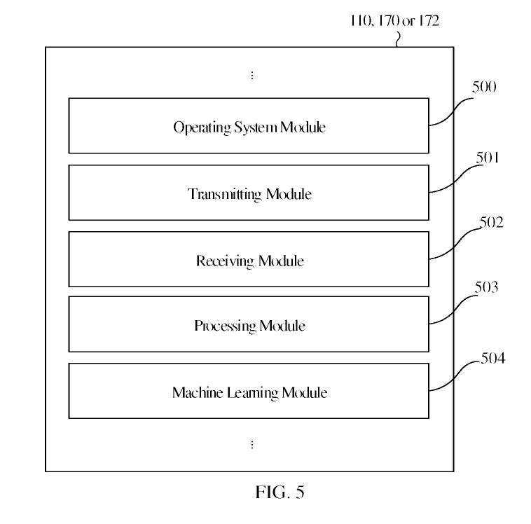

FIG. 5 is an example block diagram of a device or apparatus in accordance with representative embodiments of the present disclosure. One or more steps of the methods provided in this disclosure herein may be performed by corresponding units or modules in a device or apparatus, such as in the ED 110, in the T-TRP 170, or in the NT-TRP 172. For example, a signal may be transmitted by a transmitting unit or by a transmitting module 501. A signal may be received by a receiving unit or by a receiving module 502. A signal may be processed by a processing unit or a processing module 503. Other steps may be performed by an artificial intelligence (AI) or machine learning (ML) module 504. As shown in the FIG. 5, the device or apparatus may also include operating system module 500 (e.g., an embedded operating system, firmware, etc.). The respective units or modules may be implemented using hardware, one or more components or devices that execute software, or a combination thereof. For example, one or more of the units or modules may be a circuit such as an integrated circuit. Examples of an integrated circuit includes a programmed FPGA, a GPU, or an ASIC. For example, one or more of the units or modules may be logical such as a logical function performed by a circuit, by a portion of an integrated circuit, or by software instructions executed by a processor. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170, and the NT-TRP 172 are known to those of skill in the art. As such, these details are omitted here.

FIG. 6 shows an example of a 6G System conceptual structure according to some example embodiments of the present disclosure.

The proposed 6G System architecture is defined to support 6G XaaS services by using techniques such as Network Function Virtualization and Network Slicing. The 6G System architecture utilizes service-based interactions between 6G services.

The 6G System leverages service-based architecture and XaaS concept. XaaS services in the 6G System are categorized into three layers.

Infrastructure Layer 610 includes infrastructures supporting 6G services. Among them are wireless networks (RAN, CN) infrastructures 611,612, Cloud/data center infrastructures 614, satellite networks 613, storage/database infrastructures 615, and sensing networks and etc. These infrastructures can be provided by a single provider or by multiple providers.

Each of the infrastructures could have its control and management functions, denoted as C/M functions, for infrastructure management. Each of these infrastructures is one type of Infrastructure as a Service.

Control and Management (C/M) layer 620 includes control and management services of the 6G System. They are developed and deployed by using slicing techniques and utilizing resource provided by infrastructure layer 610. 6G services in Control and Management (C/M) layer are:

Resource Management (RM) as a Service 621 provides a capability of life-cycle management of a variety of slices and over-the-air resource assignment to wireless devices.

A 6G mission is defined as a service provided to customers by the 6G System. A mission can be a type of services which is provided by a single 6G XaaS service or a type of services that needs contributions from multiple XaaS services.

Mission Management (MM) as a Service 622 provides a capability to program provisioning of XaaS services at Service Layer to provide mission services.

Confederation Network (CONET) as a Service 625 provides a capability to enable multiple partners jointly provide 6G services. This capability is provided by confederation formation, mutual authentication, mutual authorization among partners and negotiation of agreement on recording and retracing of selected actions performed by partners, in order to assure a trustworthy environment of 6G System operations.

Service Provisioning Management (SPM) as a Service 623 provides a capability of control and management of 6G service access by customers and provisioning of requested services. The capability is provided by unified mutual authentication, authorization and policy, key management, QoS assurance and charging between any pair of XaaS service provider and customer. The customers include end-customers not only in physical world, but also digital representatives in digital world.

Connectivity Management (CM) as a Service 624 leverages 5G connectivity management functions, but with extension to include digital world.

Protocol as a Service 626 provides a capability to design service customized protocol stacks for identified interfaces.

The protocol stacks could be pre-defined for on-demand selection, or could be on-demand designed.

Network Security 627 as a Service provides a capability for owners of infrastructures to detect potential security risks of their infrastructures.

XaaS services in C/M Layer 620 support control and management of the 6G System itself and also provide support to verticals if requested. One example is that RM service can serve RAN for over-the-air resource management and can also provide service to a vertical for the vertical’s over-the-air resource allocation to its end-customers. The XaaS in C/M layer 620 can be deployed by using slicing technique.

Service Layer 630 includes 6G services which provide services to customers. In the 6G System conceptual structure:

AI service is denoted as NET4AI as a Service 631. Artificial Intelligence service provides AI capability to support a variety of AI applications.

Service of data collection, data sanitization, data analysis and data delivery are denoted as data analytics and manage (DAM) as a Service, this service provides a capability of lifecycle management of statistic data, including acquisition, de-privatization, analysis and delivery of data which are information statistic data from any types of sensors, devices, network functions, and etc.

Service of storage and sharing of data is denoted as NET4Data as a Service 632, this service provides a capability to trustworthily storage and share data under the control of owners of data and following recognized authorities’ regulations on control of identified data.

Service to provide digital world is denoted as NET4DW as a Service 635, Digital World service provides a capability to construct, control and manage digital world. Digital world is defined as digital realization of physical world.

6G block chain service is denoted as NET4BC as a Service 634. 6G connectivity service is denoted as NET4Con as a Service. This service provides a capability to support 6G block chain services.

Enhanced connectivity service, e.g., network for connectivity (NET4CON) as a service 636.

This service provides a capability to support exchange of messages and data among new 6G services.

All XaaS services at this Layer are developed and deployed by using resource provided in infrastructure and utilizing Network Function Virtualization and Slicing techniques. The capability of each of 6G services is provided by its control and management functions and service specific data process functions.

In addition to support 6G XaaS services at Service Layer, 6G System leverages 5G System for provisioning of vertical services. The difference between 6G XaaS services and other verticals are that a vertical is a pure customer which needs other XaaS services to enable its operation, while each of XaaS services provide their capabilities to 6G customers.

Any pair of XaaS services of the 6G System could also be mutual customer and provider of each other. Some of example are that an infrastructure owner provides its resource to XaaS services in Service Layer 630 and C/M Layer 620; RM services may need the capabilities provided by NET4AI 631, DAM 633 and NET4DW 635 for its resource management for vertical slicing; CONET service 625 and NET4Data service 632 may need the capability provided by NET4BC 634 for their operation.

The key concepts of 6G System includes:

Define Basic XaaS Services by decoupling comprehensive types of services into basic XaaS services. A basic XaaS service provides unique capability to enable a specific type of service, such as NET4AI service 631, NET4DW service 635, DAM service 633, NET4Data service 632, Block chain service 634, mission management service 622, etc.

Allow joint operation of the 6G System by multiple partners.

Define Data Plane of the 6G System which includes processing functions of data plane of XaaS services. Programing the interconnection of these functions, by mission management service 622, enables to support a variety of customized customer services.

Simplify 6G System architecture by categorizing basic control services and management services and combining them as basic XaaS services in Control and Management (C/M) Layer 620.

Define C/M Plane of the 6G System which includes C/M functions in XaaS services and may include 5G control plane (CP) (e.g., AMF) depending on implementation options.

Define Basic Architecture Structure (BAS) which is a unified basic structure with minimized number of interfaces and is independent of types of infrastructures.

Simplify standardization, development and deployment of the 6G System using the BAS concept, while supporting a variety of infrastructure deployment scenarios.

Adapt to a variety of deployment scenarios by applying the BAS or a subset of it to infrastructures based on capability, capacity and requirement of the infrastructure networks.

Leverage service based Interface (SBI) interface concept and apply SBI interaction in both 6G C/M plane and 6G data plane.

Simplify SBI interfaces by introducing trustworthy GWs in Data Plane and C/M Plane of the 6G System.

Improve trustworthiness from perspectives of operation of the 6G System by introducing CONET capability, NET4BC capability and anonymous service provisioning provided by the trustworthy GWs in the C/M plane and data plane of the 6G System.

Improve trustworthiness from perspective of end customer privacy protection by unified mutual authentication, ID management IDM, data sanitization and etc. provided by SPM service, data analytics and management (DAM) service and 6G Block Chain service.

Simplify roaming management of wireless devices, in physical world and digital world, by unified authentication including all participated partners and customers.

Support multiple development paths from 5G System to 6G System by defining multiple architecture options without incurring much efforts due to the introduction of the BAS concept.

Support backward compatibility by utilizing benefits of SBA and its add-on feature. 5G users can use the 6G System to access 5G services.

Support future extension by adding new XaaS services with minimized impact on standardization and deployment, due to the introduced anonymous service provisioning concept implemented in trustworthy GWs in 6G C/M plane and in 6G data plane.

For illustrative purposes, specific example embodiments will now be explained in greater detail in conjunction with the figures and the above-mentioned system, core network, ED and TRP.

Many new trends will trigger the consideration and design of 6G/future wireless networks: New network infrastructure capability, e.g., cloud natured/friendly infrastructures that are broadly deployed; new (relative) matured techniques, e.g., AI large scale models, Data de-privacy, Block chain, etc. that have made significant progresses and significantly impact on the entire society and human life; new apps and services, e.g., AI services, Data (sensing) service, Digital world service, etc. that are broadly applied in industry/business and used by individual customers; more global/open/collaborative operation trend, i.e., a more open and more collaborative operation mode are becoming common practice in many fields. New expectation and stricter requirements on future networks also drive rethinking and development of new generation of wireless networks. These requirements include privacy and trustworthiness, simplified standardization, and rapid deployment, etc. All of the above drives 6G network architecture research work.

Our proposed 6G network architecture (X-centric) are SBA (XaaS service) based and Cloud-native.

Requirements to 6G System network architecture design:

The proposed 6G network architecture needs to support new 6G services which could be developed/deployed by 3rd parties; the proposed 6G network architecture needs to embrace more open ecosystem to open door to technical capable 3rd parties; the proposed 6G network architecture needs to enable better trustworthiness management; solutions to enable above requirements are needed.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It will be understood that these concepts and applications fall within the scope of the disclosure and the accompanying claims.

In the 3GPP 5G system, an AF can request to influence traffic routing for an application by providing an indication that a common application location (where the application is located or running) should be selected for some devices. There may be more than one application location. The AF request is sent to the PCF (policy control function), which transforms the AF request into policies sent to the SMF (session management function). The SMF according to the indication selects a user plane path for a device to route a traffic related to an application from the device toward an application location, the device and the traffic both being identified in the AF request. The application location may correspond to an AS; the application location is selected from the more than one application locations by the SMF when the SMF selects the use plane path. The SMF will select the same application location for other devices identified in the AF request so that the other devices’ application traffic is also routed to the same application location (therefore possibly the same AS).

However, in the 3GPP 5G system, a device’s application traffic is routed to the same application location regardless of where the device is located, even when the device is far away from that application location. This is at the cost of user plane efficiency. Inefficient user plane can lead to degraded performance of the application for the devices. In addition, the privacy of the devices in the data plane is not very well protected in the 3GPP 5G system. Specifically, the application location receiving the traffic in the 3GPP 5G system may know which device(s) the traffic is routed (originated) from. In consequence, the private information of the device(s) may be leaked.

As can be seen from the above, it is important to select appropriate application locations for different devices. In addition, it is also important to protect the privacy of the devices in the data plane.

In light of this, in some embodiments of the present disclosure, there is provided a solution for traffic routing. In the solution, an AF sends information about traffic routing requirements (for example, the first information about traffic routing requirements described hereinafter) to a PCF. The information about traffic routing requirements is used to obtain or determine a target application location, from one or more application locations, for a device. Traffic originated from the device will be routed to the target application location.

More specifically, a method to enable anonymous communication is provided in the present disclosure. An authorized AF can request to influence traffic routing/handling for an application by sending an AF request to the system. The AF request includes information about anonymity requirements. The anonymity requirements include a k-anonymity requirement and/or an indistinguishability requirement related to routing/handling of the traffic related to the application (i.e., application traffic). Neither of the two anonymity requirements are disclosed or considered in the AF influencing on traffic routing in the 3GPP 5G system as described above.

In some embodiments, the information about anonymity requirements may comprise a k-anonymity indication, indicating the k-anonymity requirement, that is, the number of devices whose application traffic is routed to a same application location should be greater than, or not smaller than, or equal to a value (e.g., value k). The value k is referred to as anonymity value and may be included or specified in the k-anonymity indication. In details, the method described in this disclosure is related to k-anonymity provisioning during data communication in a communication system.

In some embodiments, when selecting the application location for a device (in other words, for the device’s application traffic), the system may take the k-anonymity requirement into account, and attempts to not violate or to minimize violating the k-anonymity requirement. For example, traffic originated from the device is routed to the application location (or received by a receiving network entity such as an AS, application server corresponding to the application location) in mixture with traffic originated from at least k (or k – 1) other devices.

Moreover, when multiple application locations are available for selection, different application locations may be selected for different devices for improving data plane efficiency. For example, according to the AF request, the system may connect a device to a selected application location through an efficient data plane path. And traffic related to the application and originated from the device will be routed to the application location along the data plane path. In other words, different application locations may be selected for the devices (e.g. traffic of the devices) according to the k-anonymity requirement instead of selecting only one common application location for the devices. As such user plane efficiency will be increased.

In some embodiments, the information about anonymity requirements may comprise an indistinguishability indication, indicating the indistinguishability requirement, that is, application traffic originated from different devices as identified in the device information and routed to a same application location should be indistinguishable, in other words, the application traffic should appear to be originated from a same device (e.g. include a same network address as source address).

In some embodiments, the system may configure the data plane path to perform source address translation so that application traffic originated from different devices and routed to the same application location may include a same network address as source address, thus satisfying the indistinguishability requirement, thereby ensuring the privacy protection of the devices.

In some embodiments, the AF may request to influence traffic routing/handling for an application, as further described below in accordance with FIG. 7. In this case, the AF request may include information describing the policy requirements and is sent to the PCF. The policy requirements described in the AF request are on traffic routing/handling and impact traffic coordination functionalities of the TCF in the control plane. The PCF may generate one or more policies based on the AF request (i.e. according to the policy requirements) and may send the one or more policies to the TCF. According to the one or more policies, the TCF may coordinate traffic routing in the data plane, including (re)selecting data plane path(s) for traffic related to the application, so that the traffic is routed properly as requested by the AF. Coordinating traffic routing in the data plane by the TCF may further include configuring the data plane path to perform source address translation. By using the method, user plane efficiency is increased, the privacy protection is achieved, and accordingly the user experience will be improved.

In some embodiments, the AF can provide policy requirmenets to the PCF by sending an AF request. For example, the policy requirements may be policy requirements on traffic routing or traffic handling, that is, the traffic routing requirements as described above. The AF request includes information describing the policy requirements and is sent to the PCF. The policy requirmenents may impact some control plane functionaliti(es). According to the policy requirements, the PCF geneates one or multiple policies and sends the one or multiple policies to relavant control plane function(s), e.g. control plane function(s) implementing the impacted control plane functionaliti(es). The control plane function(s) enforce(s) or respect(s)/ the one or multiple policies when performing the impacted control plane functionaliti(es).

Reference is now made to FIG. 7, which shows a signaling chart 700 for traffic routing according to some embodiments of the present disclosure. The signaling chart 700 involves the AF 309, the PCF 304, the TCF 306 and the PMF307.

In some embodiments, an application location may refer to a network location (e.g. a data center, an AN node, a CPF, an access point to a DN, or a DN) where the application is located (i.e. hosted or running); an application location may correspond to an AS. A device is considered associated to an application location if the device’s application traffic (i.e. application traffic originated from the device) is routed to the application location, or if the application location is selected to route the device’s application traffic to.

In the present disclosure, nature of the AF is not limited. That is, any network entity such as a CPF, an AS or a device can act as AF to provide police requirements. In other words, any network entity can request to influence the selection and configuration of the data plane path, so as to influence traffic routing.

In 710, the AF sends a request about traffic routing requirements to the PCF. Accordingly, the PCF receives the request.

In some embodiments, the AF may send the first information about traffic routing requirements to the PCF by sending a request (referred to as AF request), and the AF request includes the first information about traffic routing requirements. Thus, the AF may request to influence traffic routing for the application by sending a request. For example, the traffic routing requirements may be policy requirements on traffic routing or traffic handling, and the AF request may include information describing or indicating the policy requirements on traffic routing or traffic handling. Please be noted that the first information about traffic routing requirements may be carried in one or more messages. In other words, the request may correspond to one or more messages. As shown in the FIG. 7, in step 710, the AF sends the AF request to the PCF.

In some embodiments, the first information about traffic routing requirements is used to obtain or determine a first target application location, from one or more application locations, for a first device. In other words, the first target application location is selected from the one or more application locations according to the first information about traffic routing requirements. Traffic originated from the first device will be routed to the first target application location. In some embodiments, the first information about traffic routing requirements is used to obtain or determine a second target application location, from the one or more application locations, for a second device. In some embodiments, the second target application location for the second device may be the same as the first target application location or may be different from the first target application location. In other words, traffic originated from different devices may be routed to different application locations instead of being routed to a common application location according to the first information about traffic routing requirements.

The following embodiments will be illustrated with a first device as an example.

In some embodiments, the one or more application locations refers to a list of application locations that may be identified by the application location information (also referred to as information about application location). The application location information may be included in the first information about traffic routing requirements. Each of the application locations may correspond to an application server. The traffic to be routed is related to the application (and referred to as application traffic) and may be identified by traffic information. The traffic information may be included in the first information about traffic routing requirements. The first information about traffic routing requirements may indicate that the application traffic originated from a device (i.e. the application traffic of a device) should be routed to a target application location selected from the application location(s). The one or more devices whose traffic (i.e., application traffic) is routed may be identified by device information. The device information may be included in the first information about traffic routing requirements.

In some embodiments, the first information about traffic routing requirements may include a first indication (for example, the k-anonymity indication as described above). The first indication, that is, the k-anonymity indication may indicate the k-anonymity requirement as described above. More specifically, the first indication may indicate an anonymity value, and the first indication may further indicate that the number of devices whose traffic is routed to a same target application location (for example, the first target application location) is greater than or equal to the anonymity value. In some embodiments, the anonymity value is set per application location. For example, the first indication may include a plurality of anonymity values, each corresponding to an application location. One anonymity value corresponding to one application location may be the same with or different from another anonymity value corresponding to another application location. In some embodiments, the anonymity value is set for all the application locations, i.e. corresponds to all the application locations.

As described above, the first target application location is selected from the one or more application locations to receive the traffic from the first device or at least one first device. Therefore, the first indication at least includes an anonymity value corresponding to the first target application location.

In some scenarios, for privacy protection, the devices’ accessing the same target application location need to be anonymized. To meet such requirement, in some embodiments, the first information about traffic routing requirements may include a second indication (for example, the indistinguishability indication as described above) indicating that the source of the application traffic (e.g., the application traffic being originated from the at least one device) is indistinguishable to the target application location. In other words, the application traffic originated from the at least one device should appear to be originated from a same device. For example, the traffic originated from the at least one first device should appear to be originated from a same device, so the source of the traffic originated from the at least one first device is indistinguishable to the first target application location.

In some embodiments, to make sure that the application traffic originated from different devices appears to be originated from the same device, the second indication may indicate that the source of traffic originated from different devices (for example, the at least one first device) is to be identified by a same address. According to the second indication, the system may configure at least one data plane function (DPF) of the data plane path, which is used to route the traffic from the first device to the target application location, to perform source address translation, so that the application traffic originated from different devices and routed to the same application location has a same network address as the source address, and the application traffic appear to be originated from a same device. In this way, the indistinguishability requirement may be satisfied, thereby achieving privacy protection of the devices.

According to the method described above, the AF may influence the selection of the data plane path (e.g. the selection of application locations) and the configuration of the data plane path by sending an AF request including traffic routing requirements. Through this method, user plane efficiency may be enhanced, privacy protection may be ensured, consequently leading to an overall improvement in the user experience.

In some embodiments, the AF request may further include information about application location, which identifies the one or more application locations (or simply, application locations).

In some embodiments, the AF request may further include traffic information. The traffic related to the application is referred to as application traffic and is identified by the traffic information in the AF request. The traffic information may include a DNN and possibly network slice information (which can be used for selecting a network slice), or an AF-Service-Identifier (i.e. an identifier of the service on behalf of which the AF is issuing the request). When the AF-Service-Identifier is included in the traffic information, the AF-Service-Identifier is mapped to a target DNN and possibly network slice information, e.g., by a NEF. When the NEF processes the AF request the AF-Service-Identifier may be used to authorize the AF request. The traffic information may include an application identifier or traffic filtering information (e.g. IP 5 Tuple). The application identifier refers/corresponds to the application (which handles the traffic) and can be used by a DPF to detect the traffic.

In some embodiments, the AF request may include device information that identifies the one or more devices whose traffic, i.e. application traffic originated from which is to be routed. Some or all of the one or more devices may be identified as individual device. An individual device can be identified using a device identifier (ID) or an address (e.g. IP address/prefix, MAC address). Some or all of the one or more devices may be identified together as a device group. A device group can be identified using a common ID (e.g., a group ID) or a common address (e.g., a group address). The group of devices may include any device accessing the application. Hence, the device information may include a list of device ID(s), a list of address (es), a list of group ID(s), information (e.g., a special group ID, or a special device ID) indicating any device, in other words all devices accessing the application. A device ID or a group ID in the device information may be an external ID, i.e. an external device ID or an external group ID, and in this case, it may be mapped to an internal ID, i.e. an internal device ID or an internal group ID, by the NEF when the NEF processes the AF request. For example, the device information about the at least one first device may include at least one of: a first address of each of the at least one first device, a first ID of each of the at least one first device, a common address for the at least one first device (e.g., a group address), or a common ID for the at least one first device (e.g., a group ID); and the first device belongs to the group.

According to step 710, the AF request may indicate that traffic as identified in the traffic information and originated from a device as identified in the device information should be routed to an application location selected from the application location(s) as identified in the information about application location. In addition, the AF request may indicate that the source of the traffic originated from the at least one first device is to be identified by a same address. Therefore, the AF may request to influence traffic routing for the application, by sending the AF request.

In some embodiments, in step 710, the AF sends the first information about traffic routing requirements to the PCF directly or indirectly.

In the case where the AF sends the first information about traffic routing requirements to the PCF indirectly, the first information about traffic routing requirements is sent via a target network entity. The target network entity may include one or more other control plane functions. For example, the target network entity may include a network exposure function network entity (e.g. an NEF) and/or a network storage function network entity (e.g. an NSF).

In some embodiments, the AF request is sent to the PCF directly or indirectly (via one or more other control plane functions, e.g. NEF, or NEF and NSF as described above).

In some embodiments, the AF request is sent to the PCF, directly (without via the NEF). For example, when the AF is located in a trust domain or when the AF is allowed to interact with the PCF directly, the AF may send the AF request to the PCF directly without involving the NEF.

In some embodiments, the AF request is sent to the PCF indirectly via the NEF. For example, when the AF is not located in a trust domain or when the AF is not allowed to interact with the PCF directly, the AF sends the AF request to the PCF via the NEF, that is, the AF sends the AF request to the NEF which in turns sends the AF request to the PCF. In one implementation, the NEF may forward the AF request to the PCF without decoding the AF request from the AF. In another implementation, before sending the AF request to the PCF, the NEF may perform information mapping so that the AF request sent to the PCF includes mapped information.

In some embodiments, the AF request is sent to the PCF indirectly via the NSF. For example, the AF request is first sent to the NSF, and the NSF stores the AF request as application data. The PCF subscribes to receive application data related to the application from the NSF. The NSF provides the AF request to the PCF according to the subscription. In some embodiments, the PCF performs the subscription when the PCF receives request (e.g. from the TCF) for policies related to the application. In some embodiments, the AF sends the AF request to the NEF, and the NEF sends the AF request to the NSF. In some embodiments, the NEF may forward the AF request to the NSF without decoding the AF request from the AF. In another implementation, before sending the AF request to the NSF, the NEF may perform information mapping so that the AF request sent to the NSF includes mapped information.

In some embodiments, when the NEF is involved as described above during the transport of the AF request from the AF to the PCF, the NEF processes the AF request before sending the AF request to the next network entity (e.g. the PCF or the NSF). When processing the AF request, the NEF may perform information mapping. The NEF replaces/updates some information in the AF request with mapped information so that the next network entity receives the AF request with the mapped information. For example, the NEF may an AF-Service-Identifier to a DNN and possibly network slice information, an internal ID to an external ID, a zone ID to a cell ID, as described above.

In 715, the PCF validates the AF request and sends a response to the AF. This step is optional.

In some embodiments, the PCF may validate the AF request and send a response to the AF, the response indicating that the AF request has been accepted. If the AF request has failed the validation, the PCF may send another response indicating that the AF request has been rejected.

In 720, the PCF generates one or more polices.

In some embodiments, as the step 720 shown in the FIG. 7, the PCF may generate one or more polices based on the AF request from the AF. Specifically, the PCF generates second information about traffic routing requirements based on the first information about traffic routing requirements in the AF request. The one or more policies may include the second information about traffic routing requirements. The second information included in the one or more polices corresponds to the first information about traffic routing requirements in the AF request as described above. For example, the one or more policies may include information about anonymity requirements. The anonymity requirements include the k-anonymity requirement and/or the indistinguishability requirement. The one or more polices may further include at least one of the traffic information and the information about application location.

In some embodiments, as described above, the first information about traffic routing requirements may indicate an indistinguishability requirement. To meet the indistinguishability requirement, the system may configure the data plane path to perform source address translation, so that application traffic originated from different devices and routed to the same application location has a same network address as the source address.

In this case, the PCF may determine a translated address of the different devices (for example, the at least one first device) in advance for the at least one DPF to perform the source address translation. For example, three addresses (or three first addresses) of three first devices (e.g., device 01, device 02, device 03) are, for example, ADD1, ADD2, ADD3 respectively; accordingly, the original source addresses of the traffic originated from device 01, device 02, device 03 are ADD1, ADD2 and ADD3 respectively. The PCF may determine a second address (e.g., ADD0) as the translated address. In some embodiments, the second address is provided in the AF request from the AF to the PCF, e.g. as part of the indistinguishability indication in the first information about traffic routing requirements as described above. Thereafter, the system may configure the data plane path to perform source address translation based on the original source addresses and the translated address. Specifically, the source addresses of the traffic originated from device 01, device 02, device 03 may be translated from ADD1, ADD2, ADD3 to ADD0 respectively, thereby satisfying the indistinguishability requirement. In some embodiments, the PCF may further determine a translated port number corresponding to the at least one first device in advance for the data plane path to perform port number translation. The details will be further described below.

In 725, the PCF sends the second information indicating the traffic routing requirements to relavant control plane function(s) . Accordingly, the relavant control plane function(s) receive(s) the second information.

In some embodiments, after the PCF has geneated the one or more policies according to the policy requirements, the PCF sends the one or more policies to relavant control plane function(s), e.g. control plane function(s) implementing the impacted control plane functionaliti(es).

In some embodiments, as shown in the FIG. 7, the relavant control plane function is the TCF. That is, the PCF sends the one or more polices including the second information to the TCF, and the TCF correspondingly receives the one or more polices. In the following, the TCF as an example of the control plane function is described.

According to steps 720 and 725, the PCF makes policy decisions and provides resultant policy rules to control plane function(s) to enforce policy rules.

In 730, the TCF sends an acknowledgement to the PCF to acknowledge the reception of the second information (for example, as shown in the FIG. 7, the one or more policies provided by the TCF in step 725). The TCF correspondingly receives the acknowledgement. This step is optional.

In 735, the TCF coordinates traffic routing according to the received second information from the PCF.

In some embodiments, the control plane function (e.g. the TCF) coordinates traffic routing according to the second information from the PCF. In some embodiments, the TCF coordinates the routing/handling of application traffic identified in the traffic information. The application traffic may be originated from any one or more devices among those identified in the device information.

In some embodiments, after receiving the one or multiple policies from the PCF, the control plane function(s) (e.g. the TCF) enforce(s) or respect(s)/ the one or multiple policies when performing the impacted control plane functionaliti(es). For example, the TCF coordinates traffic routing according to the received one or more policies from the PCF. The one or more policies include the second information about traffic routing requirements. More specifically, the TCF coordinates traffic routing according to the second information about traffic routing requirements (simply put, the second information).

In details, step 735 includes at least one of following sub-steps.

In 7351, the TCF selects a data plane path for the first device.

In some embodiments, the TCF selects a data plane path for the first device, more specifically, for the first device’s application traffic as identified in the traffic information, according to the second information. The data plane path will be used to transport the device’s application traffic to the application location. In some embodiments, an AS corresponding to the application location receives the device’s application traffic.

In some embodiments, in the case where the second information is included in the one or more policies generated by the PCF, the TCF selects or reselects the data plane path according to the one or more policies.

In some embodiments, the TCF (re)selects a data plane path (including the application location) for a device, the device being among those identified in the device information. When (re)selecting the data plane path, the TCF selects the application location to route the device’s application traffic to, in other words, associates the device to the application location. For example, the device is the first device as described above. The TCF selects the first target application location to route the first device’s application traffic to.

In some embodiments, the application location corresponds to the AS, which receives and processes the application traffic (which is originated from the first device). The data plane path may include one or more DPFs and connects the first device and the AS. When (re)selecting the data plane path, the TCF may further select the one or more DPFs. The data plane path will be used to transport the application traffic from the device to the AS. If the device is a terminal device, the device is served by an AN node in the AN and connects with a DPF in the data plane path via the AN node. In this case, the AN node can be considered part of the data plane path. The data plane path will be used to transport application traffic originated from the device to the application location, and the data plane path may also be used to transport traffic originated from the application location and targeting the device to the device. The one or more DPFs may also be selected by the TCF. The TCF may select the application location and the one or more DPFs jointly/together for data plane efficiency.

In some embodiments, the data plane path includes a data plane function (DPF) as data plane anchor (DPA) and connects the device to an application location through the DPF. In other words, one of the one or more DPFs in the data plane path is a DPA for the device. The data plane path may further include one or more intermediate DPFs. In this case, the one or more intermediate DPFs are among the one or more DPFs described above. The DPF (i.e. the DPA) and the one or more intermediate DPFs may also be selected by the TCF. In some embodiments, the TCF may select the application location, the DPF and the one or more intermediate DPFs jointly or together for data plane efficiency.

In some embodiments, as described above, the one or more policies include information about the k-anonymity requirement. When selecting the application location, the TCF takes into account the k-anonymity requirement as described/indicated in the one or more policies to not violate or to minimize violating the k-anonymity requirement, in other words, to avoid or minimize k-anonymity dissatisfaction/violation (e.g. in terms of frequency or number of occurrences).

For example, the k-anonymity requirement is indicated by the k-anonymity indication (that is, the first indication). The k-anonymity indication indicates that the number of devices whose application traffic is routed to a same application location should be greater than a value k. For example, the number of devices associated to one application location (e.g. AL1) is k, and the number of devices associated to another application location (e.g. AL2) is (k-1). If AL1 is selected for the first device, the number of devices associated to AL1 will be increased to (k+1), in which case the k-anonymity requirement will be satisfied. If AL2 is selected for the first device, the number of devices in AL2 will be increased to k, in which case the k-anonymity requirement will still not be satisfied. In order to satisfy the k-anonymity requirement, the AL 1 will be selected for the first device.

For another example, the traffic of the first device is routed to an application location (e.g. AL3), and the k-anonymity requirement is satisfied at AL3. If the TCF wishes to select a new application location (e.g. AL4) for the first device, that is, to route the traffic of the first device to AL4 instead of AL3, but doing so may lead to dissatisfaction of the k-anonymity requirement at AL3, then in the case where violation of the k-anonymity requirement is not allowed at AL3, the TCF may decide not to select AL4 as the new application location for the first device. In another scenario, if violation of the k-anonymity requirement is not allowed at AL3, the TCF may select AL3 as the application location for all the devices associated to AL4 and/or select AL4 as the application location for all the devices associated to AL3. In this way, the application locations of some or all of the devices may be changed. As a result, the k-anonymity requirement may be satisfied at AL3. On the other hand, if violation of the k-anonymity requirement is allowed at AL3, the TCF may select AL3 or AL4 randomly or make the choice according to other factors.

For another example, there are two application locations (AL5 and AL6) available to be selected. If the k-anonymity requirement will not be satisfied whether AL5 is selected for the first device or AL6 is selected for the first device, then the satisfaction of the k-anonymity requirement will not be considered, and one of AL5 and AL6 will be selected for the purpose of traffic routing. In this case, one of AL5 and AL6 may be selected from the aspect of distance of routing. For example, if the first device is closer to AL5 compared to AL6 from the aspect of traffic routing, then AL5 will be selected.

In some embodiments, the one or more policies include information about the indistinguishability requirement. In some embodiments, when selecting the one or more DPFs, the TCF takes into account the indistinguishability requirement as described/indicated in the one or more policies to satisfy or to minimize violating the indistinguishability requirement. When selecting the one or more DPFs, according to the indistinguishability indication in the one or more policies, the TCF selects a DPF (referred to as a common DPF) that is included in (in other words, shared by) data plane paths of other devices associated to the application location, the other devices being among those identified in the device information. For example, DPF1 is included in the data plane path for Device A, when selecting the one or more DPFs for the data plane path for Device B, DPF1 may be selected by the TCF as the common DPF. Then the DPF1 may perform source address translation in step 7355 for traffic that is originated from Device A and Device B and routed to an application location (e.g. AL01). In this case, traffic that is originated from Device A and Device B and routed to AL01 appear to originate from a same device, and the indistinguishability requirement is satisfied.

In some embodiments, the DPF selected by the TCF may correspond to a RAN node. In some embodiments, the DPF is located in the RAN node. In some embodiments, the DPF is the RAN node.

For example, a first network entity or a second network entity may be configured by the TCF to perform source address translation or destination address translation in step 7355.

In some embodiments, the TCF uses the PMF to select the one or more DPFs. For example, the TCF selects the application location and sends information identifying the application location to the PMF. The TCF may further send information (e.g. an ID or network address) identifying the location of the device to the PMF, if the information is not available at the PMF. If the device is a terminal device, the location of the device corresponds to the serving AN node of the device; otherwise, the location of the device may correspond to an access point to a DN. If the TCF is integrated within (i.e. implemented by) the PCF, the information identifying the application location and the information identifying the location of the device are included in at least one policy sent from the PCF to the PMF. According to the application location and the location of the device, the PMF selects the one or more DPFs.

In 7352, The TCF identifies a k-anonymity event.

In some embodiments, the k-anonymity event (also referred to as event) is related to devices associated to an application location. The application location may be the application location selected in the step 7351(and in this case, the event is related to the device) or a different application location.

In some embodiments, when identifying the k-anonymity event, the TCF identifies whether the k-anonymity requirement as indicated in the information about anonymity requirements in the one or more policies is satisfied or dissatisfied/violated. For example, in the case where the anonymity requirements include the k-anonymity requirement (for example, the number of devices whose application traffic is routed to a same application location should be greater than, or equal to an anonymity value), the TCF will identify whether the k-anonymity requirement is satisfied, that is, whether the number of the devices whose traffic is routed to the same application location (for example, the first target application location) is greater than or equal to the anonymity value.

For example, when the number of devices associated to the application location becomes greater than, or not smaller than the anonymity value (e.g. value k), the k-anonymity requirement becomes satisfied for the devices, and a k-anonymity satisfaction event happens as a result. When the number of devices associated to the application location becomes smaller than, or not greater than the anonymity value (e.g. value k), the k-anonymity requirement becomes dissatisfied/violated for the devices, and a k-anonymity dissatisfaction/violation event happens as a result. In some embodiments, if the association between an application location and all the devices associated to it is cut off, (that is, if all the devices associated to the application location are no longer associated to the application location), it is not considered as a violation of the k-anonymity requirement. This is because in this case no application traffic will be routed to the application location any more. For example, if the k-anonymity requirement is that the number of devices whose application traffic is routed to an application location AL001 should be greater than k, and the actual number of devices whose application traffic is routed to AL001 is X, then, if X is less than or equal to k and greater than 1, the k-anonymity requirement is considered violated; but if X is greater than k or equal to 0, the k-anonymity requirement is considered satisfied.

In some embodiments, the TCF may identify more than one k-anonymity events in this step. The events may result from the (re)selection of one or more data plane paths for transporting the application traffic to one or more than one selected application location (in essence, the corresponding AS(s)). The selecting (i.e. the associating) may cause the k-anonymity requirement satisfied at the application location, i.e. satisfied for devices associated to the application location. If the device’s application traffic was routed to another application location before the selecting, the selecting may cause the k-anonymity requirement dissatisfied/violated at the other application location, i.e. dissatisfied/violated for devices associated to the other application. For example, the traffic of the first device is routed to an application location (e.g. AL7), and the k-anonymity requirement is satisfied at AL7. If the TCF has selected a new application location (e.g. AL8) for the first device, that is, the traffic of the first device is routed to AL8 instead of AL7, as a result of which the k-anonymity requirement is dissatisfied at AL7 but satisfied at AL8, then the TCF may identify more than one k-anonymity events in step 7352, and the k-anonymity events include a k-anonymity event associated to AL7 and a k-anonymity event associated to AL8. Specifically, the k-anonymity events include that the k-anonymity requirement is dissatisfied/violated at AL7, and the k-anonymity requirement is satisfied at AL8.

In some embodiments, when identifying the k-anonymity event, the TCF identifies whether the indistinguishability requirement as indicated in the information about anonymity requirements in the one or more policies is satisfied or dissatisfied/violated. In the case where the anonymity requirements include the indistinguishability requirement (for example, application traffic originated from different devices as identified in the device information and routed to a same application location should be indistinguishable), the TCF will identify whether the indistinguishability requirement is satisfied, that is, whether the source of the traffic originated from the at least one first device is indistinguishable to the same application location (for example, the first target application location).

In some embodiments, when identifying the k-anonymity event, the TCF identifies whether the k-anonymity requirement and the indistinguishability requirement are both satisfied. In the case where the anonymity requirements include both of the k-anonymity requirement and the indistinguishability requirement, the TCF will identify whether the k-anonymity requirement and the indistinguishability requirement are both satisfied.

In the case (referred to as Case 1) where the anonymity requirements include both of the k-anonymity requirement (indicated by the first indication) and the indistinguishability requirement (indicated by the second indication), the privacy protection of the devices is further enhanced. For example, the first indication indicates that the number of devices whose traffic is to be routed to a first target application location should be not less than 10, and the second indication indicates that the source of the traffic, which is originated from at least one first device, is to be indistinguishable to the first target application location. In this case, it means that at least 10 devices should send their traffic to the first target application location (e.g. AL10) at the same time. Meanwhile, the source of the traffic received by AL10 should be indistinguishable to AL10. In this way, the traffic originated from the at least 10 devices will be mixed, which enhances the privacy protection of the at least 10 devices. During a period when the at least 10 devices (device 1, device 2, device 3, …, device 10) communicates with AL10 (the at least 10 devices may not know which application location their traffic is being routed to), if some of the at least 10 devices stop communicating with AL10 (for example, device 1, device 2, device 3 and device 4 stop communicating with the server corresponding to AL10), then the number of devices that communicate with AL10 will be reduced to 6, and the k-anonymity requirement will be violated.

In some embodiments, it may be detected by the TCF whether a device (e.g. the some of the at least 10 devices mentioned above) has stopped communicating with an application location (e.g. the AL10 mentioned above). If the device is a terminal device, the TCF may detect it when the TCF find that the device is in an idle state. The TCF may be notified by the AMF when the device enters or is in the idle state. When notifying the TCF, the AMF sends a notification to the TCF indicating that the device enters or is in the idle statue. The AMF sends the notification according to a subscription to or request for the notification, the subscription/request being received from the TCF.

In some embodiments, it may be detected by a DPF (e.g. the DPA) in the data plane path of the device whether the device has stopped communicating with the application location. If no application originated from the device has been detected by the DPF for a period of time, whose length is larger than or equal to certain threshold value, the device will be considered stopped communicating with the application location, and in this case, the DPF may send a report (notification) to the TCF. The report/notification may comprise information indicating or specifying the length of the period of time. According to the report/notification from the DPF, the TCF knows and thus detect that the device has stopped communicating with the application location. In some embodiments, the TCF may configure the DPF to perform the detecting and the DPF performs the detection according to the configuration. In some embodiments, when configuring the DPF, the TCF may provide the threshold value to the DPF. In some embodiment, the threshold value is specified in a local configuration at the DPF.

The TCF may detect whether the device has stopped communicating with the application location by using any of the methods described above. In some embodiments, the choice of which method to use may be based on a local configuration.

In some embodiments, step 7352 may be performed after step 7355 and before step 7356 and step 7357.

In 7353, the TCF sends an early notification about a k-anonymity event identified in the step 7352.

In some embodiments, the early notification may indicate whether the anonymity requirement(s) is/are satisfied. The following embodiments are described with the early notification as the first notification as an example.

In some embodiments, in the case where the anonymity requirements include the k-anonymity requirement (for example, the number of devices whose application traffic is routed to a same application location should be greater than, or equal to an anonymity value), the first notification will indicate whether the number of the devices whose traffic is routed to the same application location (for example, the first target application location) is greater than or equal to the anonymity value corresponding to the application location indicated in the one or more policies (originally provided from the AF).In some embodiments, the first notification further includes information about the at least one first device (in other words, the devices associated to the first target application location). The information about the at least one first device is used to identify the at least one first device. For example, the information about the at least one first device maybe a list of IDs or network addresses.

In some embodiments, the first notification may indicate whether the indistinguishability requirement is satisfied. In some embodiments, in the case where the anonymity requirements include the indistinguishability requirement (for example, application traffic originated from different devices as identified in the device information and routed to a same application location should be indistinguishable), the first notification indicates whether the source of the traffic originated from the at least one first device is indistinguishable to the same application location (for example, the first target application location).

In some embodiments, the second address (it may be determined by one of the AF, the PCF, the TCF or the first network entity as will be described below) corresponding to the at least one first device refers to the translated address that the source address of the traffic is to be translated to, and the first notification includes information about the second address corresponding to the at least one first device. In this way, when receiving the traffic with the translated address, the AF will know which group the traffic is originated from. For example, the first address (the source addresses) of traffic originated from device C, device D and device E are translated to the second address, and the second address may be or appear to be or considered to be the source address of traffic originated from device F. After the data plane path performs source address translation for traffic originated from device C, device D and device E, it may seem that the traffic originated from device C, device D and device E are originated from a same device, and the same device may be referred to as device F with the second address. In this case, the device F is a device group that includes device C, device D and device E. As such, after receiving the first notification, the AF will know that the received traffic is originated from the same group (device F).

In some embodiments, different applications or services are identified by corresponding port numbers. When traffic is transported from the device to the application location, the port number may indicate the application on the device that is used to process the data in the traffic. Likewise, a first port number (original port number) of the device may be translated to a second port number (translated port number), and the first notification may further include the second port number corresponding to the at least one first device.

In some embodiments, a network entity that is to receive the notifications is referred to as an event notification receiver (ENR), and the ENR may respond to the first notification by sending a response. The response is sent to the TCF. The response may be a positive response, accepting the event, or a negative response rejecting the event. If the response is a negative response, the TCF may cancel the (re)selection performed in the step 7351 and repeat the step 735 to select a different application location.

Note that if the AF request is sent to the PCF via the NEF in the step 710, the first notification is sent to the ENR via the NEF, and the response is sent to the TCF also via the NEF; otherwise, the first notification is sent to the ENR without involving (i.e. via) the NEF, and the response is sent to TCF without involving (i.e. via) the NEF either.

In the case that the first notification or the response is sent via the NEF, the NEF may perform information mapping such that the first notification or response delivered to the receiver (i.e. the ENR or the TCF) includes mapped information.

In some embodiments, the TCF sends the first notification according to subscription information in the one or more policies. In some embodiments, the AF may request to receive notifications about k-anonymity events (i.e. k-anonymity satisfaction event, k-anonymity dissatisfaction/violation event). In this case, the AF request may further include subscription information indicating that the AF subscribes to receive the notifications (also referred to as event notifications). The subscription information may include information indicating whether the notifications should be sent before the one or more data plane paths are configured, or after the one or more data plane paths are configured, or both. If such an event notification is sent before the data plane path is configured, the event notification is referred to as early notification. If such an event notification is sent after the data plane path is configured, the event notification is referred to as late notification. In other words, the subscription information may indicate/ identify the type of the first notification (e.g. early notification or late notification). In some embodiments, the first notification further indicates/identifies the type of the first notification (e.g. early notification or late notification) as well.

In some embodiments, the TCF performs this step if the subscription information indicates that the first notification should be sent before the one or more data plane paths are configured. This step is optional if the first notification has been sent.

In some embodiments, the subscription information may include receiver information, e.g. a network address and/or a port number, which corresponds a network entity that is to receive the notifications. The network entity is referred to as event notification receiver (ENR). The receiver information will be used by the TCF to send the notifications so that the ENR can receive the notifications. In some embodiments, the TCF sends the first notification using the receiver information in the subscription information such that the corresponding ENR (which may be the AF or a different network entity) receives the first notification.

In some embodiments, the receiver information may be per application location. When the receiver information is per application location, the TCF will use the receiver information to send notifications about k-anonymity events related to the application location (e.g. selection or reselection or removal of the application location in a data plane path, in other words, the application location being selected or de-selected for a device). Hence, if different receiver information is provided for different application locations in the subscription information, notifications about k-anonymity events related to the different application locations may be sent to different ENRs.

In some embodiments, the TCF sends the notification using the receiver information related (applicable) to the application location. The ENR corresponding to the receiver information receives the notification. The ENR may be the AF.

In some embodiments, the ENR may respond to the notification by sending a response. The response is sent to the TCF. The response may be positive response, confirming the (re)selection of the application location, or a negative response rejecting the (re)selection. If the response is a negative response, the TCF may cancel the (re)selection performed in the step 7351 and repeat the step 735 to select a different application location.

For example, the AF may determine whether to accept the selection or reject the selection of the application location in step 7351 according to runtime status (such as load and performance) of the application location (e.g. runtime status of an AS corresponding to the application location and processing the application traffic). Specifically, if the current load at the selected first target application location is high, the AF may reject the selection, causing the system reselects a different application location for the first device.

In some embodiments, if the AF request is sent to the PCF via the NEF in the step 710, the notification is sent to the ENR via the NEF, and the response is also sent to the TCF via the NEF; otherwise, the notification is sent to the ENR without involving (via) the NEF, and the response is sent to TCF without involving (via) the NEF either.

In the case that the notification or the response is sent via the NEF, the NEF may perform information mapping such that the notification or response delivered to the receiver (i.e. the ENR or the TCF) includes mapped information.

In 7354, the TCF sends a third notification to the at least one first device. Accordingly, the at least one first device receives the third notification.

In some embodiments, the TCF sends the third notification to the at least one first device to inform the at least one first device of the result of identifying the k-anonymity event.

In some embodiments, the third notification includes the same information as the first notification. For example, the third notification may indicate whether the anonymity requirement(s) is/are satisfied and/or whether the indistinguishability requirement is satisfied. The difference between the first notification and the third notification is that the first notification it is sent to the ENR while the third notification is sent to the device.

In some embodiments, after the at least one first device receiving the third notification, the at least one first device may accordingly (i.e. according to the third notification) stop or (re)start the application traffic (e.g. stop or (re)start sending the application traffic).

In some embodiments, after the at least one first device receiving the third notification, the at least one first device may stop the application traffic if the third notification indicates that the anonymity requirement and/or the indistinguishability requirement is violated. In the case where the application traffic has been started, the at least one first device may stop the application traffic. In the case where the application traffic has not been started, the at least one first device may decide not to start the application traffic.

In some embodiments, after the at least one first device receiving the third notification, the at least one first device may accordingly (re)start the application traffic if the third notification indicates that the anonymity requirement and/or the indistinguishability requirement is satisfied. In the case where the application traffic has not been started, the at least one first device may decide to start the traffic. In the case where the application traffic has been stopped, the at least one first device may decide to restart the application traffic.

For example, in the Case 1 as described in step 7352, after the detecting the number of devices that communicate with AL10 is reduced to six, the TCF identifies that the k-anonymity requirement is violated. In this case, the TCF sends the third notification to the remaining 6 devices (i.e. device 5, device 6, device 7, device 8, device 9 and device 10). After receiving the third notification from the TCF, the remaining 6 devices may decide to stop communicating with AL10 until the anonymity requirements (the k-anonymity requirement and the indistinguishability requirement) are satisfied. For example, after the remaining six devices stopping communicating with AL10, if the traffic originated from at least four other devices (e.g. device 11, device 12, device 13 and device 14) are to be touted to AL10, in which case the number of the devices whose traffic is to be routed to the first target application location will reach 10, then the k-anonymity requirement will be satisfied. In this case, the TCF may request the devices (i.e. the device 5, device 6, device 7, device 8, device 9, device 10, device 11, device 12, device 13 and device 14) to (re)start the data communication related to the application location.

In some embodiments, the TCF sends the third notification to the at least one first device in the case where the k-anonymity requirement(s) is/are violated. For example, the TCF sends the third notification to the at least one first device in the case where the number of the devices whose traffic is routed to the first target application location is less than the value (i.e. anonymity value) indicated in the k-anonymity requirement).

In some embodiments, the TCF sends the third notification to the at least one first device in the case where the indistinguishability requirement is violated. For example, the TCF sends the third notification to the at least one first device in the case where the source of the application traffic originated from the at least one first device is distinguishable to the first target application location.

In some embodiments, the TCF sends the third notification to the at least one first device to requests or notifies the at least one first device to stop or (re)start the application traffic. In some embodiments, in the case where the k-anonymity requirement(s) is/are violated and/or the indistinguishability requirement is violated, the TCF sends the third notification to the at least one first device to request or notify the at least one first device to stop the application traffic. In some embodiments, in the case where the k-anonymity requirement(s) is/are satisfied and/or the indistinguishability requirement is satisfied, the TCF sends the third notification to the at least one first device to request or notify the at least one first device to (re)start the application traffic.

In some embodiments, the TCF performs the step 7354 according to a local configuration. The local configuration may instruct the TCF to send the third notification.

In some embodiments, the TCF performs the step 7354 further according to a synchronization indication in the one or more policies. The synchronization indication may be provided from the AF to the TCF in the AF request (e.g. as part of the first information about traffic routing requirements) in the step 710 and included in the one or more policies generated by the PCF in the step 720, e.g. as part of the second information about traffic routing requirements. If the one or more policies does not include the synchronization indication, the TCF does not perform the step 7354.

In some embodiments, the TCF performs the step 7354 further according to a capability information about the device. The TCF performs the step 7354 if the capability information indicates that the device supports the notification, and does not perform the step 7354 otherwise. The TCF may receive the capability information from the device (in an early step not shown in the FIG. 7) or from a control plane function that stores the capability information (e.g. the UDM or UDR in the 5G system when the capability information is stored in the UDM or UDR as part of the user subscription data).

In some embodiments, the notification may include information about the application, for example, a port number used by the device to perform the data communication, an ID or name that identifies the application at the device, a domain name or network address corresponding to the application. According to the notification, the device does not perform the data communication, e.g. stopping or not starting sending the application traffic. In some embodiments, the TCF performs the step 7354 early, e.g. before the step 7353 (and possibly after the step 7352).

In some embodiments, the notification is sent to the device via the interface between the TCF and the device, which is illustrated by a dashed line in the FIG. 3. In the case that the device is a terminal device, the interface is a NAS interface, and the message is a NAS message as described above.

In 7355, the TCF configures the data plane path in the data plane.

In some embodiments, the TCF performs step 7355 after receiving a positive response from the NE in the step 7352.

In some embodiments, when configuring the data plane path, the TCF configures network entities (i.e. the one or more DPFs and, if applicable, the AN node serving the device) in the data plane path to establish communication tunnels among them and configures the network entities to route the application traffic along the data plane path. If the one or more policies includes the indistinguishability indication, when configuring the data plane path, the TCF configures the data plane path to perform (using a translated address) source address translation for application traffic originated from the device (e.g. first device).In some embodiments, the TCF configures the data plane path to perform (using a translated address) source address translation for application traffic originated from the device (e.g. first device). When configuring the data plane path, the TCF configures the data plane path to perform source address translation for the application traffic using a translated address.

In some embodiments, when performing the source address translation, the first network entity translates a first address (i.e. original address), for example, the ADD1, ADD2, ADD3 mentioned above, to a second address (i.e. the translated address), for example, the ADD0 mentioned above. For example, the first network entity replaces/updates (i.e. translates) the source address (also referred to as device address) in the application traffic with/to the translated address. The device address is associated to the device and comprises a network address (referred to as device network address), e.g. an IP address or an Ethernet address. Correspondingly, the translated address comprises a translated network address. The device network address is contained in a source (address) field of a protocol header of the application traffic, e.g. the source (address) field of the IP header, or the source (address) field of the Ethernet header. The replacing/updating includes translating the device network address: changing the value of the source (address) field from the device network address to the translated network address.

Likewise, for another device (e.g. second device) associated to the application location, the TCF also configures a second data plane path to route application traffic originated from the other device (e.g. second device) to the application location. When configuring the second data plane path, the TCF configures the second data plane path to perform source address translation for the application traffic originated from the other device (e.g. second device) using a translated address. The translated address used for the other device (e.g. second device) comprise the same translated network address as that used for the device (e.g. first device) as described above. As such, after the source address translation performed for the device and that performed for the other device, the application traffic originated from the device (e.g. first device) and that from the other device (e.g. second device) are aggregated (including the same translated network address as source address) and appear to originate from a same device. The indistinguishability requirement is therefore satisfied as indicated in the information about anonymity requirements. The other device (e.g. second device) may be any other device among those associated to the application location.

In some embodiments, the TCF configures the first network entity in the data plane path to perform the source address translation by providing the one or more first traffic handling rules to the first network entity. The first network entity is one of the one or more DPFs and the AN node. In some embodiments, the first network entity may be the DPF that the TCF selects in step 7351. In some embodiments, the first network entity is also included in the second data plane path mentioned above and configured by the TCF to perform the source address translation for the application traffic originated from the other device (e.g. second device).

In some embodiments, the one or more first traffic handling rules may indicate how to detect the application traffic originated from the device and may further indicate whether and how to perform the source address translation on the application traffic. According to the one or more first traffic handling rules, the first network entity may detect the application traffic and, if the source address translation should be performed on the application traffic, perform the source address translation before routing the application traffic along the data plane path toward the application location.

In some embodiments, the one or more first traffic handling rules may include the application ID or traffic filtering information in the traffic information (which is in the one or more policies described above), for indicating how to detect the application traffic. The one or more first traffic handling rules may include the device address, the translated address or both. The translated address may be included for indicating how to perform the source address translation. The device address may be included for indicating how to perform the source address translation. The device address may be included also for indicating how to detect the application traffic.

In some embodiments, the TCF sends the one or more first rules (also referred to as traffic handling rules) to the first network entity (e.g. a DPF or an AN node). As described above, the first network entity belongs to the data plane path, and the data plane path is used to route the application traffic originated from the first device to the first target application location and the one or more first rules instruct the first network entity to translate the first address (e.g. network address) of the first device to the second address (i.e. translated address) in the case where the traffic is routed from the first device to the target application location. In some embodiments, the one or more first rules include the first address of the first device and/or the second address. The first network entity will, as configured by the TCF, perform the source address translation when the application traffic is transported (in other words, routed) from the device toward the application location along the data plane path.

In some embodiments, the second address is provided in the AF request from the AF to the PCF, as part of the first information about traffic routing requirements (for example, in the indistinguishability indication). In some embodiments, the second address may be determined by one of the PCF, the TCF or the first network entity. In some embodiments, the second address may be determined by the PCF when the PCF generates the one or more policies. The second address may be included in the one or more policies and may be sent to the TCF along with the one or more policies. After receiving the one or more policies, the TCF generates one or more first rules, which include the second address. Then, the TCF may send the one or more first rules that include the second address to the first network entity. In some embodiments, the second address may be determined by the TCF and may be included in the one or more first rules to be sent to the first network entity. In some embodiments, the second address may not be included in the one or more policies or the one or more first rules, but may be determined by the first network entity.

In some embodiments, the one or more first rules include the first address (e.g., network address) of the first device and the second address (i.e. translated address). For example, the one or more first rules include the first address (e.g. ADD1) of device 01, the first address (e.g. ADD2) of device 02, the first address (e.g. ADD3) of device 03, in this case, ADD1 is the source address of the traffic originated from device 01, ADD2 is the source address of the traffic originated from device 02, ADD3 is the source address of the traffic originated from device 03. In addition, the one or more first rules further include the second address (e.g. ADD0). In this way, when performing source address translation for traffic originated from device 01, device 02 and device 03, the first network entity may translate ADD1, ADD2, ADD3 to ADD0, such that after the source address translation, the traffic originated from device 01, device 02 and device 03 includes ADD0 as the source address respectively. In this way, the traffic originated from device 01, device 02 and device 03 are identified by a same address (ADD0) indicating that the traffic is from a same source.

In some embodiments, if the one or more first rules include the first address(es) of the at least one first device as source address(s) of the traffic originated from the at least one first device but not the second address (i.e. translated address), then the first network entity may determine the second address by itself, such that the traffic after the source address translation includes the second address as source address. In some embodiments, the first network entity may notify the TCF about the second address, for example, by sending a message to the TCF, the message including the second address. The notification may further include the first address and indicates that the first address is being translated to the second address. The first network entity may notify the TCF about the second address according to a request from the TCF, and in this case, the notification may be included in or used as a response to the request.

In some embodiments, if the one or more first rules include the second address but not the first address of the first device, the first network entity may translate the source addresses of all the received application traffic to the second address. The first network entity may notify the TCF about the second address, for example, by sending a message to the TCF, the message including the second address. The notification may any source address in the application traffic is being translated to the second address. The first network entity may notify the TCF about the second address according to a request from the TCF, and in this case, the notification may be included in or used as a response to the request.

In some embodiments, the one or more first rules further instruct the first network entity to translate the first port number (i.e. original port number) of the first device to the second port number (i.e. translated port number) in the case where the traffic is transported from the first device toward the first target application location (instead of vice versa).

Likewise, the second port number may be determined by one of the PCF, the TCF or the first network entity.

In some embodiments, the device address may further comprise a port number (referred to as device port number). Correspondingly, the translated address comprises a translated port number. The device port number is contained in a source port field of a protocol header of the application traffic, e.g. the source port field of the UDP header or the source port field of the TCP header. The replacing/updating includes translating the device port number: changing the value of the source port field from the device port number to the translated port number. Hence, performing the source address translation includes the translating the device network address and the translating the device port number. In some embodiments, the one or more first traffic handling rules indicate whether to translate the device port number, and the first network entity translates the device port number when the one or more first traffic handling rules indicate to do so.

In some embodiments, the device address may be provided from the TCF to the first network entity, as part of the one or more first traffic handling rules. In some embodiments, when the device address comprises the device network address and the device port number, only the device network address is provided from the TCF to the first network entity.

In some embodiments, the translated address may be provided from the TCF to the first network entity, as part of the one or more first traffic handling rules as described above. In some embodiments, when the translated address comprises the translated network address and the translated port number, only the translated network address is provided from the TCF to the first network entity, while the translated port number is determined/generated by the first network entity. When the translated port number is determined/generated by the first network entity, the first network entity may provide the translated port number to the TCF and inform the TCF about the translation (in other words, mapping), that the device port number is translated to the translated port number.

In some embodiments, the application may use the translated address (included in the application traffic) to send traffic, for example, in response to the application traffic. The protocol header(s) of the traffic includes the translated address, more specifically, includes the translated network address as destination address. The traffic is thus aggregated traffic potentially comprising traffic targeting the device and another device. When the translated address comprises only the translated network address, it cannot be identified which one of the devices associated to the application location the traffic is targeting, and thus the traffic cannot be disaggregated (i.e. routed to the device definitely). When the translated address comprises both the translated network address and the translated port number, the translated address can identify the device, and the traffic can be disaggregated accordingly.

In some embodiments, the TCF configures the data plane path to further perform destination address translation for traffic originated from the application location and targeting the device, for example, when the traffic can be disaggregated as described above. The TCF configures the date plane path to perform the destination address translation by configuring a second network entity in the data plan path to perform the destination address translation. The second network entity will, as configured by the TCF, perform the destination address translation when the traffic is transported from the application location toward the device along the data plane path. When configuring the second network entity, the TCF may provide a one or more second traffic handling rules to the second network entity. The one or more second traffic handling rules indicate how to detect the traffic and may further indicate whether and how to perform the destination address translation. According to the one or more second traffic handling rules, the second network entity detects the traffic and, if the destination address translation should be performed, performs the destination address translation, and then routes the traffic along the data plane path toward the device.

In some embodiments, the TCF may further configure the second network entity in the data plane path to perform the destination address translation by providing the one or more second traffic handling rules to the second network entity. The second network entity belongs to the data plane path. The second network entity may be a DPF or an AN node. In some embodiments, the second network entity may be the DPF that the TCF selects in step 7351.

In some embodiments, the TCF sends one or more second rules to the second network entity. The one or more second rules instruct the second network entity to perform the destination address translation for the traffic originated from the application location to the at least one first device in the case where the traffic is transported from the first target application location toward the first device. For example, the one or more second rules instruct the second network entity to translate the second address (i.e. translated address) to the first address (i.e. original address) of the first device.

In some embodiments, the one or more second traffic handling rules may include the translated address and/or the device address. The translated address may be included for indicating how to detect the traffic. The translated address may be included also for indicating how to perform the destination address translation. The device address may be included for indicating how to perform the destination address translation.

In some embodiments, the translated address includes the translated network address as described above. When the traffic includes the translated address as destination address, the traffic includes the translated address as destination address in the protocol headers of the traffic. More specifically, the translated network address is contained in a destination (address) field of a protocol header of the traffic, e.g. the destination (address) field of the IP header, or the destination (address) field of the Ethernet header. The second network detects the traffic when the second network entity identifies that the traffic includes the translated address as destination address as described above. When performing the destination address translation for the traffic, the second network entity replaces/updates the destination address (which is the translated address used for the source address translation described above) in the traffic with/to the device address. The replacing/updating includes changing the value of the destination (address) field from the device network address to the translated network address.

In the case where performing the source address translation includes translating the device network address and translating the device port number, accordingly, performing the destination address translation includes translating the device network address and translating the device port number.

In some embodiments, the one or more second rules further instruct the second network entity to translate the second port number to the first port number of the first device in the case where the traffic is transported from the first target application location toward the first device. In this case, the translated address further includes the translated port number as described above. The translated port number may be contained in a destination port field of a protocol header of the traffic, e.g. the destination port field of the UDP header or the destination port field of the TCP header. When performing the destination address translation for the traffic, the second network entity replaces/updates the port number (which is the translated port number used for the source address translation described above) in the traffic with/to the device address. The replacing/updating includes changing the value of the destination port field from the translated port number to the device port number.

In some embodiments, the first network entity and the second network entity may each be the AN node (if applicable) or a DPF in the data plane path. In some embodiments, the first network entity and the second network entity may be the same network entity. In some embodiments, only the device network address is included in the one or more second traffic handling rules when the translated address is available at the second network entity (e.g. available in the one or more first traffic handling rules when the first network entity and the second network entity are the same network entity). In some embodiments, if when the first network entity and the second network entity are the same network entity, the one or more first traffic handling rules and the one or more second traffic handling rules are integrated/merged.

In some embodiments, the TCF performs step 7355 by using the PMF. For example, the TCF sends the one or more first traffic handling rules and the one or more second traffic handling rules to the PMF, and the PMF provides them respectively to the first network entity and the second network entity. In another example, the TCF sends information (e.g. the traffic filtering information or the application identifier, the device address, the translated address) used for generate the one or more first traffic handling rules and one or more second traffic handling rules to the PMF. The information is referred to as rule generating information. Using the rule generating information, the PMF generates the one or more first traffic handling rules and the one or more second traffic handling rules using the information received from the TCF and provides them to the first network entity and the second network entity respectively.

In some embodiments, if the TCF uses the PMF to select the one or more DPFs in the data plane path, the TCF may send the one or more first traffic handling rules and the one or more second traffic handling rules, or the rule generating information to the PMF in the step 7351, for example, when the TCF sends the information identifying the application location and the information identifying the location of the device to the PMF as described in the step 7351.

In some embodiments, the PMF may select the DPF and the one or more intermediate DPFs of the data plane path. For example, the DPF and the one or more intermediate DPFs are not completely selected by the TCF in step 7351, and the DPF and the one or more intermediate DPFs may be partially selected by the PMF instead. The PMF may select the application location, the DPF and the one or more intermediate DPFs jointly or together for data plane efficiency.

In 7356, the TCF sends a late notification about the k-anonymity event identified in the step 7353.

The following embodiments are described with the late notification as the second notification as an example.

The second notification plays the same role as the first notification. The difference between the second notification and the first notification is that the second notification is sent after the data plane path is configured while the first notification is sent before the data plane path is configured.

In some embodiments, the second notification may indicate whether the anonymity requirement(s) is/are satisfied. In some embodiments, in the case where the information about anonymity requirements includes the k-anonymity requirement, the second notification indicates whether k-anonymity requirement(s) is/are satisfied.

In some embodiments, in the case where the information about anonymity requirements includes the indistinguishability requirement, the second notification indicates whether the indistinguishability requirement is/are satisfied.

In some embodiments, the second notification further includes information about the at least one first device. The information about the at least one first device is used to identify the at least one first device.

In some embodiments, the second notification includes information about the second address corresponding to the at least one first device. The second address corresponding to the at least one first device refers to the translated address that the source address of the traffic is to be translated to.

In some embodiments, the TCF sends the second notification according to the subscription information in the one or more policies.

In some embodiments, the TCF sends the second notification using the receiver information in the subscription information such that the corresponding ENR (which may be the AF or a different network entity) receives the notification. In some embodiments, the TCF performs the step 7356 if the subscription information indicates that the notification should be sent after the k-anonymity event (also referred to as the event). Since the event notification is sent after the data plane path is configured, the event notification is referred to as late notification. Step 7356 is optional if the first notification has been sent.

In the step 7356, the ENR may respond to the second notification by sending a response. The response is sent to the TCF. The response may be positive response, accepting the event, or a negative response rejecting the event. If the response is a negative response, the TCF may cancel the (re)selection performed in the step 7351 and the configuring performed in the step 7355, and repeat the step 735 to select a different application location.

Note that if the AF request is sent to the PCF via the NEF in the step 710, the second notification is sent to the ENR via the NEF, and the response is sent to the TCF also via the NEF; otherwise, the second notification is sent to the ENR without involving (i.e. via) the NEF, and the response is sent to TCF without involving (i.e. via) the NEF either.

In the case that the second notification or the response is sent via the NEF, the NEF may perform information mapping such that the second notification or response delivered to the receiver (i.e. the ENR or the TCF) includes mapped information.

In 7357, the TCF sends a fourth notification to the at least one first device. Accordingly, the at least one first device receives the fourth notification.

In some embodiments, the TCF sends the fourth notification to the at least one first device to inform the at least one first device of the result of identifying the k-anonymity event.

In some embodiments, the fourth notification includes the same information as the first notification. For example, the fourth notification may indicate whether the anonymity requirement(s) is/are satisfied and/or whether the indistinguishability requirement is satisfied. The difference between the first notification and the fourth notification is that the first notification it is sent to the ENR while the fourth notification is sent to the device.

In some embodiments, after the at least one first device receiving the fourth notification, the at least one first device may accordingly (i.e. according to the fourth notification) stop or (re)start the application traffic (e.g. stop or (re)start sending the application traffic).

In some embodiments, after the at least one first device receiving the fourth notification, the at least one first device may stop the application traffic if the fourth notification indicates that the anonymity requirement and/or the indistinguishability requirement is violated. In the case where the application traffic has been started, the at least one first device may stop the application traffic. In the case where the application traffic has not been started, the at least one first device may decide not to start the application traffic.

In some embodiments, after the at least one first device receiving the fourth notification, the at least one first device may accordingly (re)start the application traffic if the fourth notification indicates that the anonymity requirement and/or the indistinguishability requirement is satisfied. In the case where the application traffic has not been started, the at least one first device may decide to start the traffic. In the case where the application traffic has been stopped, the at least one first device may decide to restart the application traffic.

In some embodiments, the TCF sends the fourth notification to the at least one first device in the case where the k-anonymity requirement(s) is/are satisfied. For example, the TCF sends the fourth notification to the at least one first device in the case where the number of the devices whose traffic is routed to the first target application location is not less than the value (i.e. anonymity value) indicated in the k-anonymity requirement).

In some embodiments, the TCF sends a fourth notification to the at least one first device in the case where the indistinguishability requirement is satisfied. For example, the TCF sends the fourth notification to the at least one first device in the case where the source of the application traffic originated from at least one first device is indistinguishable to the first target application location.

In some embodiments, the TCF sends the fourth notification to the at least one first device to requests or notifies the at least one first device to stop or (re)start the application traffic. In some embodiments, in the case where the k-anonymity requirement(s) is/are violated and/or the indistinguishability requirement is violated, the TCF sends the fourth notification to the at least one first device to request or notify the at least one first device to stop the application traffic. In some embodiments, in the case where the k-anonymity requirement(s) is/are satisfied and/or the indistinguishability requirement is satisfied, the TCF sends the fourth notification to the at least one first device to request or notify the at least one first device to (re)start the application traffic.

For example, the TCF notifies the device that data communication related to the application can be performed. The TCF performs the step 7357 if a k-anonymity event identified in the step 735 is related to the device and is about the k-anonymity requirement being satisfied.

In some embodiments, the TCF performs the step 7354 according to a local configuration. The local configuration may instruct the TCF to send the fourth notification.

In some embodiments, the TCF performs the step 7357 further according to a synchronization indication in the one or more policies. As described in the step 7354, the synchronization indication may be provided from the AF to the TCF in the AF request (e.g. as part of the first information about traffic routing requirements) in the step 710 and included in the one or more policies generated by the PCF in the step 720, e.g. as part of the second information about traffic routing requirements. If the one or more policies does not include the synchronization indication, the TCF does not perform the step 7357.

In some embodiments, the TCF performs the step 7357 further according to a capability information about the device. The TCF performs the step 7357 if the capability information indicates that the device supports the notification, and does not perform the step 7357 otherwise. The TCF may receive the capability information from the device (in an early step not shown in the FIG. 7) or from a control plane function that stores the capability information (e.g. the UDM or UDR in the 5G system when the capability information is stored in the UDM or UDR as part of the user subscription data).

In some embodiments, the fourth notification may include information about the application, for example, a port number used by the device to perform the data communication, an ID or name that identifies the application at the device, a domain name or network address corresponding to the application. According to the fourth notification, the device starts to perform the data communication, e.g. sending the application traffic. In some embodiments, the TCF performs the step 7357 early, e.g. before the step 7356 (and possibly after the step 7355).

In some embodiments, the fourth notification is sent to the device via the interface between the TCF and the device, which is illustrated by a dashed line in the FIG. 3. In the case that the device is a terminal device, the interface is a NAS interface, and the message is a NAS message as described above.

In 740, data traffic is transported between the device and the application location (in essence, the corresponding AS) along the data plane path.

In some embodiments, source address translation and/or destination address translation may be performed when the traffic is transported between the device and the application location. For example, source address translation is performed by the first network entity when the traffic is transported from the device(s) toward the application location. For another example, destination address translation is performed by the second network entity when the traffic is transported from the application location toward the device(s).

In some embodiments, similarly, port number translation may be performed when the traffic is transported between the device and the application location.

FIG. 8 is a flow chart illustrating a method by an AF in accordance with some embodiments of the present disclosure. In step 801, the AF sends first information about traffic routing requirements to a PCF. The first information about traffic routing requirements includes a first indication and/or a second indication. The first indication indicates a value, and the first indication indicates that a number of devices whose traffic is to be routed to a target application location is greater than or equal to the value. The target application location is to receive traffic from at least one first device. The second indication indicates that a source of the traffic originated from the at least one first device is to be indistinguishable to the target application location.

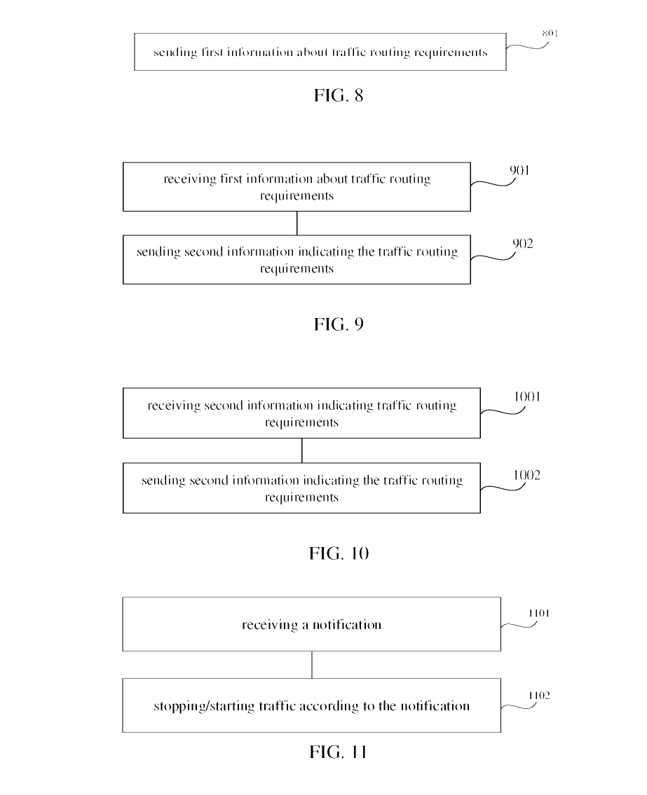

FIG. 9 is a flow chart illustrating a method by a PCF in accordance with some embodiments of the present disclosure. In step 901, the PCF receives the first information about traffic routing requirements from the AF. The first information about traffic routing requirements includes the first indication and/or the second indication. The first indication indicates a value, and the first indication indicates that the number of devices whose traffic is to be routed to the target application location is greater than or equal to the value. The target application location is to receive traffic from at least one first device. The second indication indicates that a source of the traffic originated from the at least one first device is to be indistinguishable to the target application location. In step 902, the PCF sends second information indicating the traffic routing requirements to a TCF, and the second information is generated based on the first information about traffic routing requirements.

FIG. 10 is a flow chart illustrating a method by a TCF in accordance with some embodiments of the present disclosure. In step 1001, the TCF receives the second information indicating traffic routing requirements from the PCF. The second information includes the first indication and/or the second indication. The first indication indicates a value, and the first indication indicates that the number of devices whose traffic is to be routed to the target application location is greater than or equal to the value. The target application location is to receive traffic from at least one first device. The second indication indicates that a source of the traffic originated from the at least one first device is to be indistinguishable to the target application location. In step 1002, the TCF the target application location from one or more application locations, for the at least one first device, based on the second information.

FIG. 11 is a flow chart illustrating a method by a device in accordance with some embodiments of the present disclosure. In step 1101, the device receives a notification from a TCF. The notification indicates whether a number of devices whose traffic is routed to a target application location is greater than or equal to a value and/or whether a source of the traffic originated from at least one device is indistinguishable to the target application location. In step 1102, the device stops/starts traffic (i.e. application traffic) according to the notification. The device stops the traffic according to the notification in a case where the number of the devices whose traffic is routed to the target application location is less than the value and/or in a case where the source of the traffic originated from the at least one device is distinguishable to the target application location. The device starts the traffic according to the notification in a case where the number of the devices whose traffic is routed to the target application location is greater than or equal to the value and/or in a case where the source of the traffic originated from the at least one device is indistinguishable to the target application location.

The method in the present disclosure allows the AF to dynamically provide anonymity requirements (i.e. k-anonymity requirement, indistinguishability requirement) on traffic routing/handling and influence the TCF’s decision on traffic routing coordination for an application. When the TCF selects an application location for the device in the step 7351, the TCF respects the k-anonymity requirement and attempts to not violate or to minimize violating the k-anonymity requirement. When are multiple application locations available for selection, different application locations may be selected for different devices for improving data plane efficiency. The TCF configures the data plane path to perform source address translation so that application traffic originated from the device has a same network address as source address as application traffic originated from other devices associated to the application location, thus satisfying the indistinguishability requirement. By satisfying the k-anonymity requirement and the indistinguishability requirement, the system provides strong privacy protection for the devices in the data plane and meanwhile allows improvement of data plane efficiency.

In some aspects of the present disclosure, there is provided a computer program comprising instructions. The instructions, when executed by a processor, may cause the processor to implement a method of the present disclosure.

In some aspects of the present disclosure, there is provided a non-transitory computer-readable medium storing instructions, the instructions, when executed by a processor, may cause the processor to implement a method of the present disclosure.

In some aspects of the present disclosure, there is provided an apparatus/chipset system comprising means (e.g., at least one processor) to implement a method implemented by (or at) a UE of the present disclosure. The apparatus/chipset system may be a network entity illustrated in this disclosure, e.g., AF, PCF, TCF, Device (that is, a terminal device) or a module/component in the network entity. In details, the at least one processor may execute instructions stored in a computer-readable medium to implement the method.

In some aspects of the present disclosure, there is provided a system comprising at least two of the mentioned network entities e.g., AF, PCF, TCF, Device illustrated in this disclosure.

In some aspects of the present disclosure, there is provided a method performed by a system comprising at least two of the mentioned network entities illustrated in this disclosure.

Please note that two or more of the network entities illustrated in this disclosure may be located in physical network entity, or to be implemented as a single function entity. In this case, the interaction between the two or more of the mentioned network entities may be not needed, i.e., the corresponding step(s) may be ignored (optional).

Please note that although two or more network entities are illustrated in this disclosure, only one of them may be enough for an example solution in this disclosure. For example, in the example shown in FIG. 7, from AF side, only an AF request and response are needed. For operations executed by other network entities (e.g., step 720-730), the AF does not see it (or they may be transparent to the AF).

The solutions described in the disclosure is applicable to a next generation (e.g. sixth generation (6G) or later) network, or a legacy (e.g. 5G, 4G, 3G or 2G) network.

It will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device/apparatus or accessible or connectable thereto. Computer/processor readable/executable instructions to implement a method, an application or a module described herein may be stored or otherwise held by such non-transitory computer/processor readable storage media.

It could be noted that the message in the disclosure could be replaced with information, which may be carried in one single message, or be carried in more than one separate message.

The terms “apparatus” and “device” are used exchangeable.

In the disclosure, the word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

In the disclosure, the words “first”, “second”, etc., when used before a same term (e.g., ED, or an operating step) does not mean an order or a sequence of the term. For example, the “first ED” and the “second ED”, means two different EDs without specially indicated, and similarly, the “first step” and the “second step” means two different operating steps without specially indicated, but does not mean the first step have to happen before the second step. The real order depends on the logic of the two steps.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

The term “receive”, “detect” and “decode” as used herein can have several different meanings depending on the context in which these terms are used. For example, without special note, the term “receive” may indicate that information (e.g., DCI, or MAC-CE, RRC signaling or TB) is received successfully by the receiving node, which means the receiving side correctly detect and decode it. In this scenario, “receive” may cover “detect” and “decode” or may indicates same thing, e.g., “receive paging” means decoding paging correctly and obtaining the paging successfully, accordingly, “the receiving side does not receive paging” means the receiving side does not detect and/or decoding the paging. “paging is not received” means the receiving side tries to detect and/or decoding the paging, but not obtain the paging successfully. The term “receive” may sometimes indicate that a signal arrives at the receiving side, but does not mean the information in the signal is detected and decoded correctly, then the receiving side need perform detecting and decoding on the signal to obtain the information carried in the signal. In this scenario, “receive”, “detect” and “decode” may indicate different procedure at receiving side to obtain the information. Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description. When combining two or more embodiments, not all the features in the embodiments to be combined are necessary for the combination.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

What is claimed is:

1. A method performed by an application function (AF) network entity, the method comprising:
sending first information about traffic routing requirements to a policy control function (PCF) network entity, wherein the first information about traffic routing requirements includes at least one of:
a first indication indicating a value, wherein the first indication indicates that a number of devices whose traffic is to be routed to a target application location is greater than or equal to the value, and the target application location is to receive traffic from at least one first device; or
a second indication indicating that a source of the traffic originated from the at least one first device is to be indistinguishable to the target application location.

2. The method of claim 1, wherein the second indication indicates that the source of the traffic originated from the at least one first device is to be identified by a same address.

3. The method of claim 1, wherein the first information about traffic routing requirements further includes at least one of:
device information about one or more devices, wherein the at least one first device belongs to the one or more devices;
application location information about one or more application locations, wherein the one or more application locations include the target application location; or
traffic information about traffic originated from the one or more devices.

4. The method of claim 3, wherein the device information about the at least one first device includes at least one of:
a first address of each of the at least one first device, a first identifier (ID) of each of the at least one first device, a common address for the at least one first device, or a common ID for the at least one first device.

5. The method of claim 1, wherein the first information about traffic routing requirements further includes subscription information indicating subscription of one or more notifications, and each notification of the one or more notifications indicates whether the number of the devices whose traffic is routed to the target application location is greater than or equal to the value, or whether the source of the traffic originated from the at least one first device is indistinguishable to the target application location.

6. The method of claim 5, further comprising at least one of:
receiving a first notification from a traffic coordination function (TCF) network entity, wherein the first notification indicates whether the number of the devices whose traffic is routed to the target application location is greater than or equal to the value; or
receiving a second notification from the TCF network entity, wherein the second notification indicates whether the source of the traffic originated from the at least one first device is indistinguishable to the target application location.

7. The method of claim 6, wherein the first notification includes at least one of:
information about the at least one first device;
a second address corresponding to the at least one first device; or
a second port number corresponding to the at least one first device.

8. The method of claim 6, wherein the second notification includes at least one of:
information about the at least one first device;
second address corresponding to the at least one first device; or
second port number corresponding to the at least one first device.

9. The method of claim 6, wherein:
the first notification further indicates a type of the first notification; or
the second notification further indicates a type of the second notification.

10. The method of claim 1, further comprising:
sending a synchronization indication to a traffic coordination function (TCF) network entity, wherein the synchronization indication requests the TCF network entity to send a third notification to the at least one first device, and the third notification indicates at least one of whether the number of the devices whose traffic is routed to the target application location is greater than or equal to the value or whether the source of the traffic originated from the at least one first device is indistinguishable to the target application location.

11. The method of claim 1, further comprising at least one of:
sending a synchronization indication to a traffic coordination function (TCF) network entity, wherein the synchronization indication requests the TCF network entity to send a third notification to the at least one first device in a case where the number of the devices whose traffic is routed to the target application location is less than the value or in a case where the source of the traffic originated from the at least one first device is distinguishable to the target application location, and the third notification requests the at least one first device to stop the traffic; or
the synchronization indication requests the TCF network entity to send a fourth notification to the at least one first device in a case where the number of devices whose traffic is routed to the target application location is greater than or equal to the value or in a case where the source of the traffic originated from the at least one first device is indistinguishable to the target application location, and the fourth notification requests the at least one first device to start the traffic.

12. The method of claim 1, wherein sending the first information about traffic routing requirements to the PCF network entity includes:
sending the first information about traffic routing requirements to the PCF network entity via a target network entity.

13. A method performed by a policy control function (PCF) network entity, the method comprising:
receiving first information about traffic routing requirements from an application function (AF) network entity, wherein the first information about traffic routing requirements includes at least one of:
a first indication indicating a value, wherein the first indication indicates that a number of devices whose traffic is to be routed to a target application location is greater than or equal to the value, and the target application location is to receive the traffic from at least one first device; or
a second indication indicating that a source of the traffic originated from the at least one first device is to be indistinguishable to the target application location; and
sending second information indicating the traffic routing requirements to a traffic coordination function (TCF) network entity, wherein the second information is generated based on the first information about traffic routing requirements.

14. The method of claim 13, wherein sending the second information indicating the traffic routing requirements to the TCF network entity includes:
sending one or more policies to the TCF network entity, wherein the one or more policies include the second information, and the one or more policies are generated based on the first information about traffic routing requirements.

15. The method of claim 13, wherein the second indication indicates that the source of the traffic originated from the at least one first device is to be identified by a same address.

16. The method of claim 13, wherein the first information about traffic routing requirements further includes at least one of:
device information about one or more devices, wherein the at least one first device belongs to the one or more devices;
application location information about one or more application locations, wherein the one or more application locations include the target application location; or
traffic information about traffic originated from the one or more devices.

17. The method of claim 13, wherein the first information about traffic routing requirements further includes subscription information indicating subscription of one or more notifications, and each notification of the one or more notifications indicates at least one of whether the number of the devices whose traffic is routed to the target application location is greater than or equal to the value, or whether the source of the traffic originated from the at least one first device is indistinguishable to the target application location.

18. The method of claim 13, wherein the one or more policies further include at least one of a second address corresponding to the at least one first device or a second port number corresponding to the at least one first device.

19. The method of claim 13, wherein receiving the first information about traffic routing requirements from the AF network entity includes:
receiving the first information about traffic routing requirements from the AF network entity via a target network entity.

20. A communication system comprising:
an application function (AF) network entity;
a policy control function (PCF) network entity; and
a traffic coordination function (TCF) network entity;
wherein the AF network entity is configured to: send first information about traffic routing requirements to the PCF network entity, wherein the first information about traffic routing requirements includes at least one of:
a first indication indicating a value, wherein the first indication indicates that a number of devices whose traffic is to be routed to a target application location is greater than or equal to the value, and the target application location is to receive traffic from at least one first device; or
a second indication indicating that a source of the traffic originated from the at least one first device is to be indistinguishable to the target application location;
wherein the PCF network entity is configured to:
receive the first information about traffic routing requirements from the AF network entity; and
send second information indicating the traffic routing requirements to the TCF network entity, wherein the second information is generated based on the first information about traffic routing requirements; and
the TCF network entity is configured to:
receive second information indicating traffic routing requirements from a policy control function (PCF) network entity, wherein the second information indicating traffic routing requirements includes at least one of the first indication or the second indication
obtain the target application location from one or more application locations, for the at least one first device, based on the second information.
